(19) United States
(12) Patent Application Publication
(10) Pub. No.: US 2025/0253326 A1
(43) Pub. Date: Aug. 7, 2025

(54) A BATTERY MATERIAL AND ITS MANUFACTURE

(71) Applicant: TIOTECH AS, Nesttun (NO)

(72) Inventors: Robert CORKERY, Stockholm (SE); Lene HOLLUND, Tørvikbygd (NO); Gabriella RABELLO DOS SANTOS, Bergen (NO); Evgeniya KHOMYAKOVA, Trondheim (NO); Nazia Sainudeen NAZER, Nesttun (NO)

(21) Appl. No.: 18/860,541

(22) PCT Filed: Apr. 28, 2023
(86) PCT No.: PCT/EP2023/061279

§ 371 Date: Oct. 25, 2024

(30) Foreign Application Priority Data
Apr. 29, 2022 (SE) 2250523-4

(51) Int. Cl. H01M 4/48; C01G 23/08; H01M 4/02; H01M 4/36; H01M 4/485; H01M 4/62

(52) U.S. Cl. CPC H01M 4/483; C01G 23/08; H01M 4/364; H01M 4/485; H01M 4/625; C01P 2002/72; C01P 2002/82; C01P 2004/03; C01P 2004/50; C01P 2004/64; C01P 2006/11; C01P 2006/12; C01P 2006/14; C01P 2006/40; H01M 2004/021

(57) ABSTRACT

There is disclosed a powder for a Li-ion battery anode and its manufacture, comprising manufacturing a dispersion comprising titanium dioxide primary particles. Thereafter the dispersion comprising primary particles is spray dried or jet milled to obtain spherical secondary particles comprising the primary particles. Thereafter the powder are calcined so that the primary particles are fused together to form the secondary particles. In addition to the method the particles, a battery anode comprising the particles, a battery cell comprising the anode, a battery pack comprising the battery cells, a battery pack including a control system are provided. Advantages include high capacities and performance with very low losses in the first few cycles for the batteries. Improved control of the particle properties is possible.

### TECHNICAL FIELD

The present invention relates generally to the manufacture of particles comprising TiO₂. The particles are secondary particles, where the secondary particles are comprised of primary particles. The present invention further relates to a slurry comprising the particles, a battery anode comprising the particles, a battery cell comprising the anode, a battery pack comprising the battery cells, a battery pack including a control system as well as a method for charging/discharging and a computer readable medium. Further, the present invention relates to the manufacture of the particles using spray drying.

### BACKGROUND

Particles as well as nanoparticles comprising TiO₂ are well known and widely used within many different applications.

Kumar and Rao in Nanoscale 2014, vol 6, pp 11574-11632 is a review article about phase transitions in titania (TiO₂).

WO 2016/198689 discloses a method for manufacturing a photocatalytic particle comprising the steps of:
a) providing at least one titanic acid with the general formula [TiOx(OH)₄₋₂ₓ]ₙ and soluble in at least one selected from the group consisting of TiOCl₂, TiCl₄, and HCl, and dissolving it in a solution comprising at least one selected from the group consisting of TiOCl₂, TiCl₄, and HCl, wherein the pH of the solution is lower than 1,
b) optionally adding at least one crystal habit modifier,
c) heating to a temperature in the interval 68-85° C., wherein the heating is performed with at least 0.3° C./min,
d) holding the temperature in the temperature 68-85° C. interval during 1-180 minutes, during stirring,
e) cooling to obtain a dispersion comprising particles with at least one core, said at least one core comprising anatase, and said at least one core having a crystal structure with crystal planes, said at least one core being in close contact with a first layer, said first layer is at least partly surrounding said at least one core, said first layer comprising at least one selected from the group consisting of TiO₂, TiO₍₂₋ₓ₎, and TiO₂*H₂O, said first layer is partly ordered, said first layer comprising parts where molecules are aligned with an imaginary extension of the crystal planes of said at least one core,
f) treating the dispersion to increase or decrease the content of ions, and adjusting the pH to a value in the range from 0.5 to 2.5, in order to add to the particles a second layer comprising at least one selected from the group consisting of layered titanium dioxide, and titanium dioxide in TiO₂ (B)-form, said second layer is partly ordered, and said second layer comprising sheets aligned with crystal planes transversal to the outer surface of said particle.

E. Ventosa et al in ChemSusChem 2013, 6, 1312-1315 discloses a method for manufacturing a material for anode material in Li-ion batteries. Titanium oxysulfate sulfuric acid hydrate was dissolved in nitric acid solution (1 molL⁻¹) by stirring for at least 4 h. Subsequently, the TiO₂ precursor material was continuously spray-dried. The powder was calcined at 600 or 700° C., allowing for sufficient time to flush out volatile species evolving during the decomposition of the precursors. After calcination the samples were thoroughly washed with distilled water and dried in static air at 110° C. for 24 h.

J. Mater. Chem. A, 2018, 6, 11916 discloses a high-tapdensity nanosphere-assembled microcluster for a TiO₂ anode. A tap density of 1.7 g/cm³ is disclosed. Pore volumes of 0.29, 0.33, 0.38 and 0.40 cm³/g are disclosed. Spray drying is not disclosed.

Sci China Mater 2017, 60 (4): 304-314 discloses mesoporous titania submicrospheres with high tap densities for Li-ion batteries. Tap density of 1.62 g/cm³ is disclosed. The secondary particles are about 200-330 nm. Spray drying is not disclosed.

WO 2008/114667 and JP 5400607 disclose an electrode active material containing secondary particles each of which is composed of aggregated titanium oxide primary particles and has a void volume within the range of 0.005-1.0 cm³/g. Also disclosed is a lithium battery using such an electrode active material. The secondary particles are preferably obtained by spraying and drying a slurry containing primary particles of a specific titanium oxide. More preferably, the secondary particles are prepared by using a titanium oxide, which is obtained by neutralizing and hydrolyzing a hydrolyzable titanium compound in a medium liquid and then heating the resulting in the medium liquid for grain growth, as primary particles. The primary particle size is 1-500 nm, preferably 1-100 nm. The secondary particle size is 1-50 μm. The tap density is disclosed as 0.5-2 g/cm³. In the examples the tap densities vary in the interval 0.7-1.2 g/cm³, as seen in table 1 of WO 2008/114667 in the rightmost column.

It is a problem in the prior art how to make TiO₂ for batteries at commercial scale with relatively high capacities and rate performance and that do not suffer to any significant extent from the common problem of anatase, namely large losses in the first few cycles.

In particular, it is a problem how to obtain a higher capacity for a battery manufactured of the material according to the invention and how to obtain a good first cycle efficiency for a battery.

### SUMMARY

It is an object of the present invention to alleviate at least some of the disadvantages in the prior art and provide a material as well as a method for manufacturing of particles.

In a first aspect there is provided a calcined powder, wherein the powder comprises secondary particles, wherein the secondary particles are comprised of primary particles, wherein the primary particles comprise titanium dioxide,
wherein the primary particles have a diameter in the interval 5-20 nm,
wherein the secondary particles comprise mesopores formed by a space between the primary particles, wherein the mesopores have a volume in the range 0.1-0.5 cm³/g and a size in the range 2-15 nm,
wherein the tap density of the calcined powder is in the range 1.0-1.9 g/cm³,
wherein the powder has an angle of repose of 28.5° or less,
wherein the powder has a BET surface area (A) expressed in m²/g fulfilling the equation

$$A \geq 420 - 262 ρ$$

wherein ρ is the tap density expressed in g/cm³ and as measured above

In a second aspect there is provided a battery anode for at least one selected from the group consisting of a lithium ion battery and a sodium ion battery, wherein the battery anode comprises the calcined powder.

In a third aspect there is provided a battery cell comprising the battery anode.

In a fourth aspect there is provided a battery pack comprising at least one battery cell.

In a fifth aspect there is provided a method for manufacturing a calcined powder, the method comprising the steps of:
a. providing at least one titanic acid with the general formula [TiOₓ(OH)₄₋₂ₓ]ₙ and soluble in at least one selected from the group consisting of TiOCl₂, TiCl₄, and HCl, and dissolving it in a solution comprising at least one selected from the group consisting of TiOCl₂, TiCl₄, and HCl, wherein the pH of the solution is lower than 1,
b. heating to a temperature in the interval 68-110° C., wherein the heating is performed with at least 0.3° C./min,
c. holding the temperature in the temperature 68-110° C. interval during 1-180 minutes, during stirring to form a dispersion comprising primary nanoparticles comprising anatase,
d. cooling the dispersion,
e. adjusting the ion content of the dispersion comprising primary nanoparticles
f. optionally treating the dispersion to neutralize the dispersion to a pH in the range from 4.5 to 5.5,
g. spray drying the dispersion to obtain a powder, wherein the powder after step g) comprises secondary particles comprised of primary particles,
h. drying the powder and then calcining the powder in a temperature in the range 300-650° C. to obtain a calcined powder comprising secondary particles comprised of primary particles,
wherein the powder is washed in water to decrease the content of ions in the powder at least before or after step h).

In a sixth aspect there is provided a method of charging or discharging of the battery pack, the method comprising:
receiving a measured temperature of the battery pack,
controling the temperature of the battery pack based on the measured temperature to maintain the temperature of the battery pack within a predetermined temperature range during charging and/or discharging of the battery pack.

In a seventh aspect there is provided a computer-readable medium having stored thereon instructions that, when executed by one or more processors, cause execution of the method of of charging or discharging of the battery pack.

An advantage is that the powder, when used in an anode in a Li-ion battery has high capacity and performance and that it does not suffer from any significant losses in the first cycle, i.e. the first cycle efficiency is good.

Further, the tap density is high, while the transport properties of Li-ions in the material still is high. The powder morphology is thus highly suitable for battery anodes.

A benefit of these materials is their expected performance in batteries for fast charging and discharging and long lifetime applications, reduced fire hazards and ease of manufacture at the ton scale.

The powder has an excellent uniformity throughout the material, also when manufactured at large scale.

An advantage of forming the primary particles prior to spray drying is that this allows control of the primary crystal size independent of the spray drying. It further allows greater flexibility when adding additives during spraying, i.e. using co-spraying with other particles or chemicals such as binders, carbons etc with the various benefits this affords, eg mixing conducting carbon and nanoparticles at the primary particle level. Yet another advantage is that is it possible to control the amorphous to crystalline fraction via the thermal treatment after spray-drying since a substantially amorphous titania is obtained in the primary particles.

Forming the primary particles first before spray will further allow improved control over the mesoporosity of the spray particles. Hence, it is possible to affect the Li-ion diffusion rate in and out in the material in a battery.

The particles have a very good tap density favorable for increasing the mass density of the battery electrode and thereby keeping its volume relatively low. The spherical nature of the particles is an advantage in processing compared to rougher particle shapes, as the spherical particles will pack in a predictable and repeatable manner during handling and when formed into an electrode and provide consistent pore spaces for the electrolyte. The spherical shape of the particles will also be a benefit in simplifying predictive modeling of electrochemical performance relative to a rougher particle. The spherical shape will also be a benefit in coating for enhanced interparticle conduction. The spherical shape of the particles is attributed to the spray drying of a dispersion comprising nanoparticles.

The spray drying step gives a narrower size distribution for the secondary particles, which is an advantage. More specifically it is believed that the spray drying gives less fine particles, which may give a more dense packing and hence less good flow through the material for a liquid. Particles with a wide size distribution will pack more densely because of the different sizes of the particles so that a flow of liquid through the particles is hampered. The narrower size distribution of the secondary particles and the lower amount of very fine particles will give a packing which allows a flow of liquid through the material, which is an advantage when washing the material since unwanted ions are washed away easier. Thus, the spray drying gives a more efficient removal of unwanted ions during the manufacturing.

The spray drying further give a faster method, since the spray drying is faster compared to drying without spraying.

### BRIEF DESCRIPTION OF THE DRAWINGS

The invention is now described, by way of example, with reference to the accompanying drawings, in which:

FIG. 1 shows the capacity versus tap density for powders. Circles are from samples A-H, J, M-R, square is from sample S. Capacities were not determined for powders I-L.

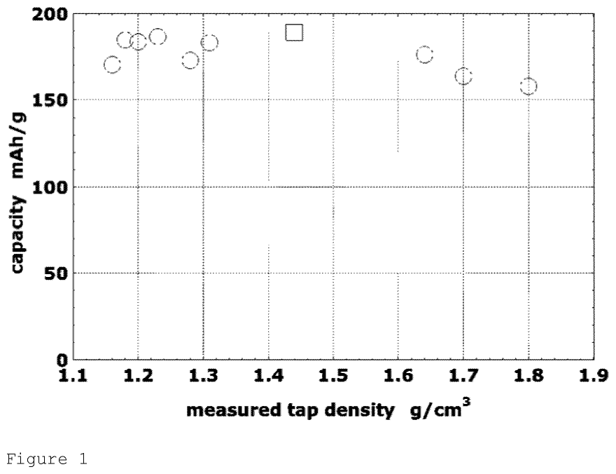

FIG. 2 shows the X-ray diffraction pattern for powder P.

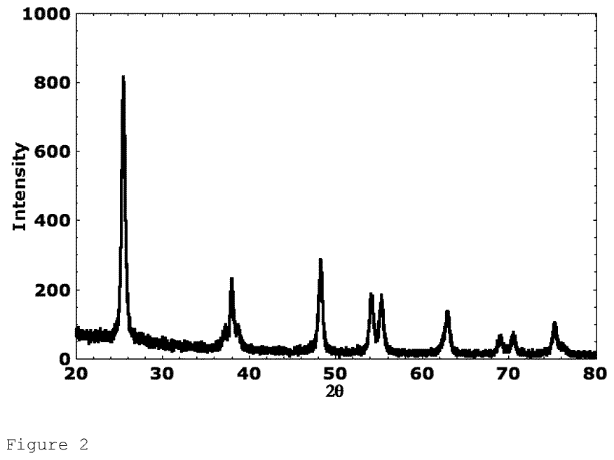

FIG. 3 shows a Raman spectrum for powder H.

FIG. 4 shows the pore sizes versus tap density for powders. Circles are adsorption pore sizes for samples A-H, J and H-R. Square is adsorption pore size for sample S. Triangles are desorption pore sizes for samples A-H, J and H-R. Square is desorption pore size for sample S. The lines are a fourth order polynomial fit to guide the eye to the overall trend of the data set. Pore sizes were not determined for powders I, K or L.

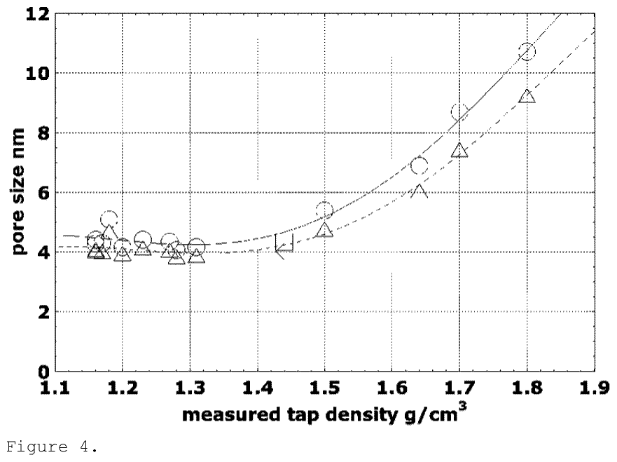

FIG. 5 show pore volumes versus tap density for powders. Circles represent samples A-H, M-R, and square represents sample S. Pore sizes were not determined for powders I, K or L. The line is a linear regression fit to guide the eye to the overall trend of the data set.

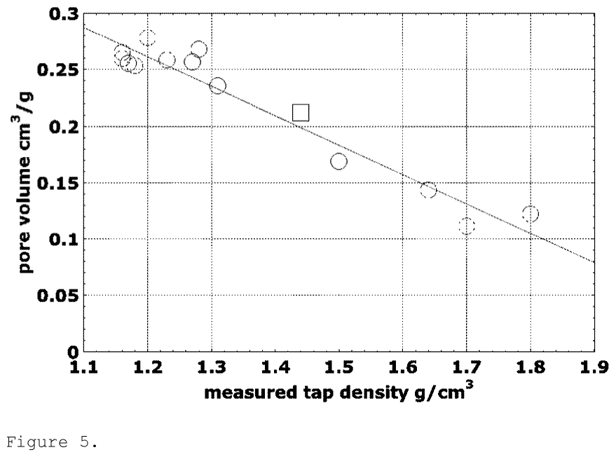

FIG. 6 shows the BET Specific surface areas versus tap density for powders. Circles represent samples A-H, M-R, and square represents sample S. Surface areas were not determined for powders I, K or L. The line is a linear regression fit to guide the eye to the overall trend of the data set.

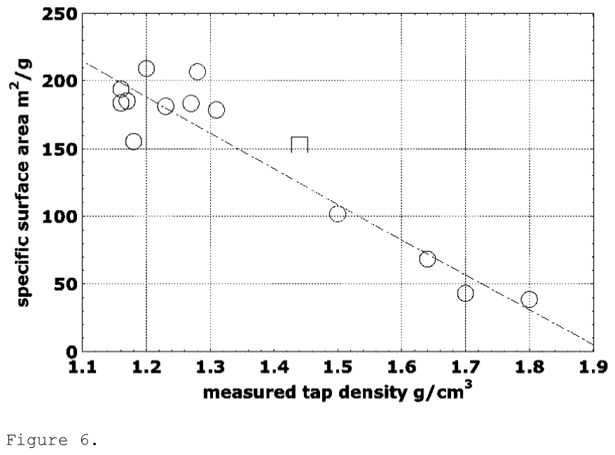

FIG. 7 shows the BJH desorption pore size distribution dV/dlog (D) versus pore diameter for powder A. This sample is the least heat treated and indicative of the very tight pore size distribution in the un-calcined precursor to powders A-P in example 7.

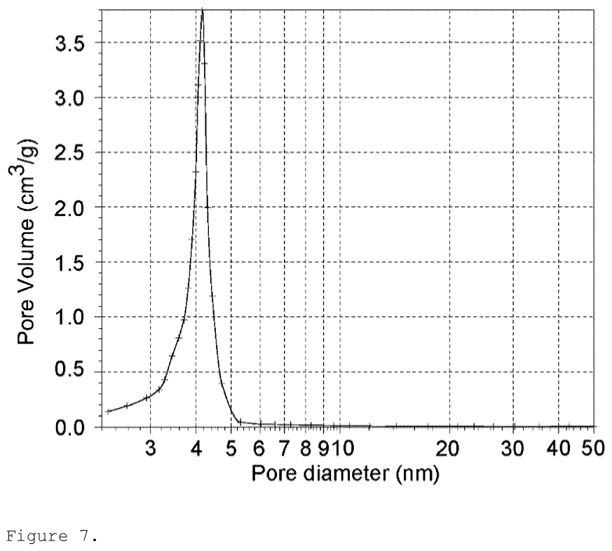

FIG. 8 shows the XRD crystal size versus tap density for powders. Circles represent samples A-P. The curve is a second order polynomial fit to guide the eye to the overall trend of the data set.

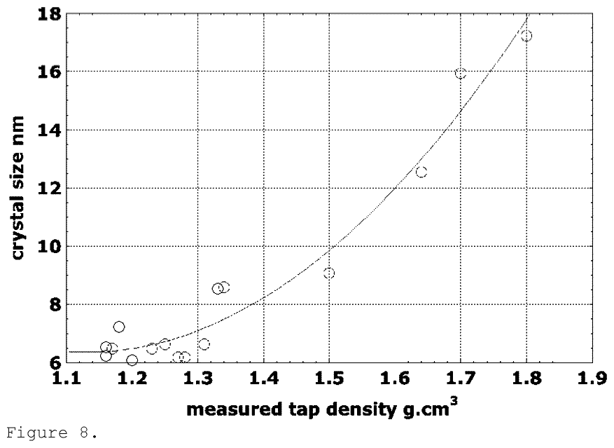

FIG. 9 shows the predicted versus measured tap density for powders. Circles represent samples A-H, J and M-P. Surface areas were not determined for powders I, K or L. The line is a linear regression fit to indicate the goodness of the model to the data.

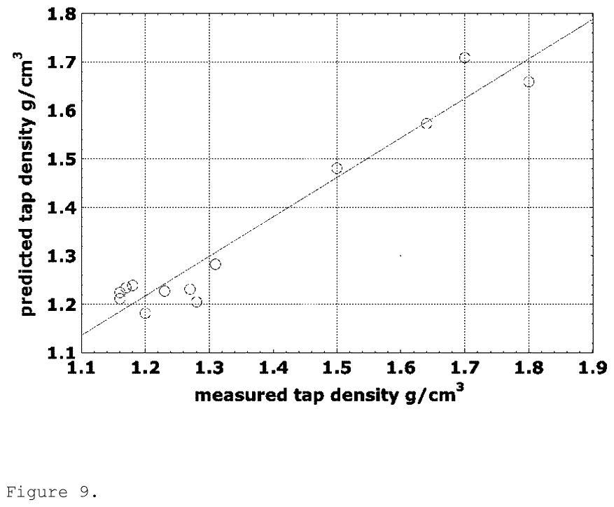

FIG. 10 shows the capacity versus cycle number for powder A. Each data point represents the average values for three coin cells.

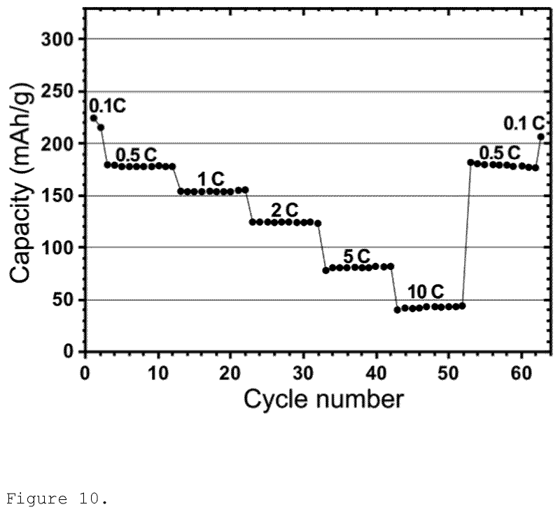

FIG. 11 shows the voltage versus capacity for powders from example 13. Circles-pure lithium titanate. Crosses-80% anatase secondary particles. Triangles-60% anatase secondary particles. Inverted triangles-40% anatase secondary particles.

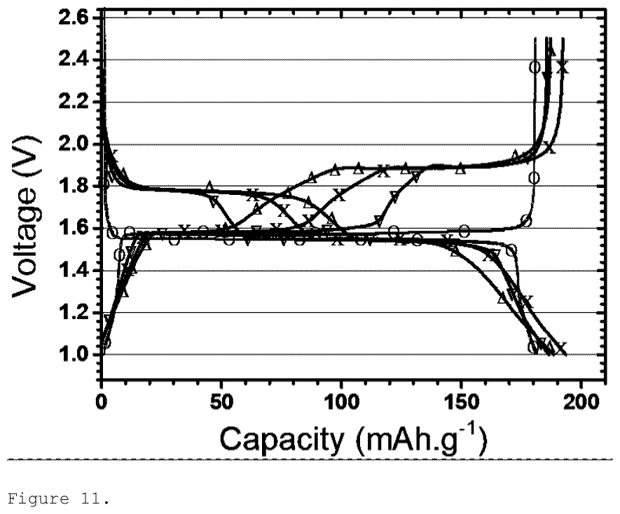

FIG. 12 shows a scanning electron microscope image of a secondary particle from sample E.

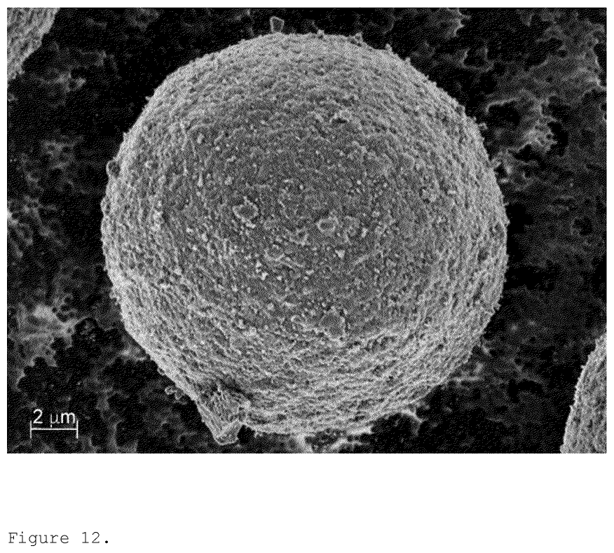

FIG. 13 shows a schematic diagram of a secondary particle. A-exterior surface of the secondary particle. B-pores within the secondary particle. C-primary particles. It can be seen that the secondary particle comprises a plurality of primary particles.

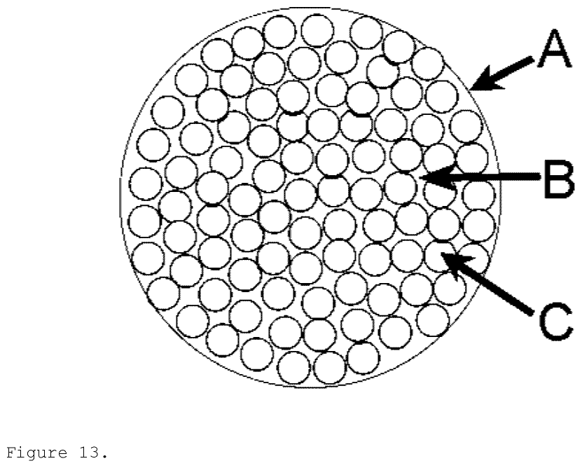

FIG. 14 shows the angle of repose versus tap density. Circles represent spray dried samples A*, D, P, A #, Q* and W* and R*. Squares represent samples Q**, R**, S*, S**, V* and V**. See Table 3 for values. The line with constant angle of repose=28.5° is indicated.

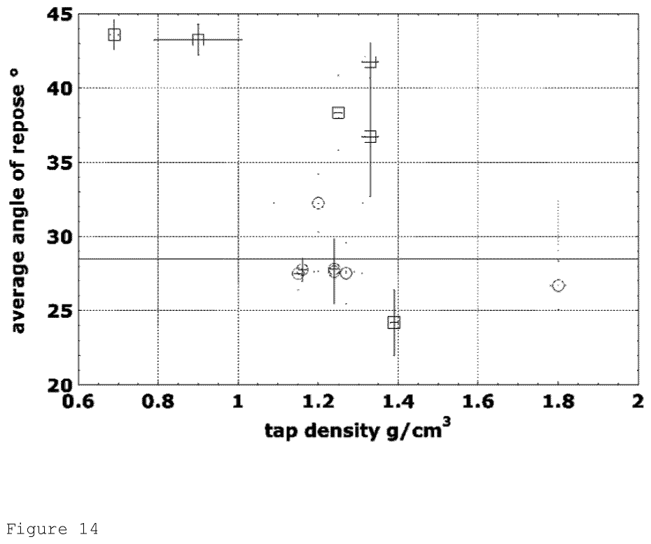

FIG. 15 shows the BET specific surface area versus tap density. Circles-samples A-H, J, M-P. Square-sample S. Diamonds-electrode active materials A, B, J and K from Table 1 of WO 2008/114667. The line represents the equation A=420-262ρ, where A is the BET specific surface area and p is the tap density.

FIG. 16 shows a schematic diagram of a simple battery cell. The battery cell comprises a working anode (1), a counter electrode (2), a separator (3), a lower casing (4), an upper casing (5), and a gasket (6). In this particular embodiment, the working anode (1) comprises an electrode material made by the method according to the invention. The casing (4, 5) encloses the electrolyte (7).

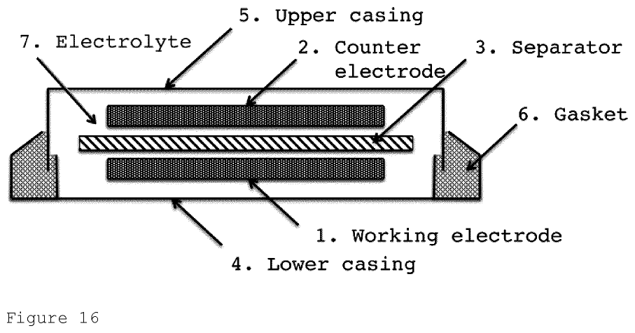

FIG. 17 shows a graph from a measurement according to example 29.

### DETAILED DESCRIPTION

Before the invention is disclosed and described in detail, it is to be understood that this invention is not limited to particular compounds, configurations, method steps, substrates, and materials disclosed herein as such compounds, configurations, method steps, substrates, and materials may vary somewhat. It is also to be understood that the terminology employed herein is used for the purpose of describing particular embodiments only and is not intended to be limiting since the scope of the present invention is limited only by the appended claims and equivalents thereof.

It must be noted that, as used in this specification and the appended claims, the singular forms “a”, “an” and “the” include plural referents unless the context clearly dictates otherwise.

If nothing else is defined, any terms and scientific terminology used herein are intended to have the meanings commonly understood by those of skill in the art to which this invention pertains.

Angle of repose as used herein is measured according to the method reported in Carlson et al in ASM Handbook, Volume 7: Powder Metal Technologies and Applications P. W. Lee, Y. Trudel, R. Iacocca, R. M. German, B. L. Ferguson, W. B. Eisen, K. Moyer, D. Madan, and H. Sanderow, editors, p 287-301 (1998). The angle of repose is defined as the angle the surface of an unconstrained pile of powdered TiO₂ makes with a horizontal surface. We use the fixed-base cone method described on page 299. The powder is allowed to flow through a funnel, which is raised vertically until the heap covers a circular base of fixed size. The tangent of the angle of repose is the ratio of the height to the mean radius of the base of the powder heap. In the experiments, we poured powders onto a flat printing paper taped to a hard horizontal surface. The powder was poured through a 100 ml plastic funnel, with an opening chosen to give slow flow that did not collapse the peak of the powder pile as the funnel was raised during the experiment. The funnel was kept 2-5 mm above the growing apex of the powder pile. A typical flow rate meant the powder pile was fully poured after approximately 1-2 minutes, depending on the powder. Experiments were not counted if the powder apex collapsed at the end of the experiment. On the paper was printed close spaced, fixed radii concentric rings with radii 3 cm to 10 cm. Three repeat pours were made and in each repeat, the radii were measured at 8 points from overhead photographs and averaged. A single estimate of the height was made using a vertical graduated scale mounted next to the pile and measured using a movable horizontal beam lowered to touch the top of the pile, checking the horizontal with a spirit level. An estimate of the uncertainty was made from the standard deviation of the average radii of the three repeats, accounting for the uncertainty of ±0.25 mm in the individual estimates of radius and an uncertainty of 0.5 mm was used in the estimate vertical of height.

Secondary particles as used herein refer to a collection of primary particles, which stick together and have formed a larger entity.

Calcined as used herein refers to a thermal treatment of the material.

Dispersion as used herein refers to a system in which particles are dispersed in a continuous phase of a different composition. The term dispersion includes but is not limited to suspensions, colloids, and sols.

Mesoporous as used herein refers to a material with pores with diameters between 2 and 50 nm.

Nanoparticle as used herein is a particle of matter that is between 1 and 100 nm in diameter.

Particle as used herein refers to a small piece of matter. A secondary particle within the invention comprises a plurality of primary particles.

The pH value is measured throughout using reference buffer solutions according to ISO 23496:2019.

Powder as used herein refers to a plurality of particles. Typically but not necessarily, the powder has a low content of moist, water or other liquids so that it is free flowing. Tap density as used herein is measured according to the method described by Carson et al in ASM Handbook, Volume 7: Powder Metal Technologies and Applications P. W. Lee, Y. Trudel, R. Iacocca, R. M. German, B. L. Ferguson, W. B. Eisen, K. Moyer, D. Madan, and H. Sanderow, editors, p 287-301 (1998).

The invention starts by making an acidic dispersion of TiO₂ anatase nanoparticles, which are primary particles. Thereafter sodium hydroxide is added to at least partially neutralize the dispersion. The neutralizing step is in one embodiment, omitted. It is possible to neutralize to different pH values. This will give a different pH value of the dispersion when the particles are dispersed in water. Thereby it is possible to tune the pH value of the dispersion. The dispersion of primary particles comprising TiOz anatase is spray dried to obtain a powder and then washing excess ions out, followed by drying, then calcining the powder to obtain a free flowing powder comprised of secondary particles of TiO₂.

In the prior art, particles are typically formed during spray drying, however by first making nanoparticles in a dispersion and then spray drying the already formed particles a number of advantages can be obtained.

The acid dispersion is not necessarily neutralized. In one embodiment, the spray drying occurs by spraying an acidic dispersion of titania after a reduction of the ion content of the dispersion. It is also possible to omit the reduction of the ion content before spray drying. In one embodiment, the dispersion of nanoparticles with a high ion content, is optionally neutralized and spray dried to also obtain particles that contain substantial salts that when washed out leave porosity in the particles that enhances the transfer of ions in and out of the electrolyte during cycling.

In the first aspect there is provided a calcined powder, wherein the powder comprises secondary particles, wherein the secondary particles are comprised of primary particles, wherein the primary particles comprise titanium dioxide, wherein the primary particles have a size in the interval 5-20 nm (as measured according to ISO 19749:2023 and thereafter calculating the average particle size from the particle size distribution using the moment method according to ISO 9276-2:2014), wherein the secondary particles comprise mesopores formed by a space between the primary particles, wherein the mesopores have a volume as measured by ISO 15901-2:2006 in the range 0.1-0.5 cm³/g and a size in the range 2-15 nm, wherein the tap density of the calcined powder is in the range 1.0-1.9 g/cm³, as measured using the method described by Carson et al in ASM Handbook, Volume 7: Powder Metal Technologies and Applications P. W. Lee, Y. Trudel, R. Iacocca, R. M. German, B. L. Ferguson, W. B. Eisen, K. Moyer, D. Madan, and H. Sanderow, editors, p 287-301 (1998), wherein the powder has an angle of repose of 28.5° or less measured according to the fixed base cone method described by Carlson et al in ASM Handbook, Volume 7: Powder Metal Technologies and Applications P. W. Lee, Y. Trudel, R. Iacocca, R. M. German, B. L. Ferguson, W. B. Eisen, K. Moyer, D. Madan, and H. Sanderow, editors, p 287-301 (1998), wherein the powder has a BET surface area (A) expressed in m²/g and measured according to ISO 9277:2010 fulfilling the equation

$$A \geq 420 - 262 ρ$$

wherein ρ is the tap density expressed in g/cm³ and as measured above.

The primary particles have been heat-treated and thereby adhere to each other forming secondary particles. The primary particles have been fused together to form secondary particles.

In one embodiment, the mesopores have a volume as measured by ISO 15901-2:2006 in the range 0.1-0.4 cm³/g. In one embodiment, the mesopores have a volume as measured by ISO 15901-2:2006 in the range 0.1-0.3 cm³/g. In one embodiment, the mesopores have a volume as measured by ISO 15901-2:2006 in the range 0.15-0.4 cm³/g. In one embodiment, the mesopores have a volume as measured by ISO 15901-2:2006 in the range 0.2-0.3 cm³/g. In one embodiment, the mesopores have a volume as measured by ISO 15901-2:2006 in the range 0.25-0.3 cm³/g. In one embodiment, the mesopores have a size according to ISO 15901-2:2006 in the range 3-10 nm. In one embodiment, the mesopores have a size according to ISO 15901-2:2006 in the range 2-10 nm. In one embodiment, the mesopores have a size according to ISO 15901-2:2006 in the range 3-9 nm. In one embodiment, the mesopores have a size according to ISO 15901-2:2006 in the range 4-8 nm. In one embodiment, the mesopores have a size according to ISO 15901-2:2006 in the range 4-9 nm. In one embodiment, the mesopores have a size according to ISO 15901-2:2006 in the range 3-8 nm.

It has turned out that by using a higher tap density compared to the prior art a number of advantages can be obtained. It is possible to obtain a higher capacity for a battery where the powder is used for the anode. It is also possible to obtain a better first cycle efficiency for a battery with the powder. While the capacity and first cycle efficiency is improved the flow of ions and electrons in the material is still excellent so that other properties of the battery are great as well.

Regarding the tap density it should be high to obtain a desired high energy density, but it should not be so high that the transport of Li-ions is negatively impacted. A tap density in the interval 1.0-1.9 g/cm³ is suitable.

For the material according to the invention, it turns out that the capacity is optimal when the tap density is in the range 1.0-1.6 g/cm³.

When it comes to the first cycle efficiency, it has turned out that a slightly higher tap density gives the optimum value. The first cycle efficiency is optimal when the tap density is in the range 1.6-1.9 g/cm³.

Thus if the capacity of the finished battery is most important then the tap density is optimized for the best capacity. If the first cycle efficiency is most important then the tap density is optimized for the best first cycle efficiency. It is however also possible to find a range for the tap density where both the capacity and the first cycle efficiency are good. Such a tap density is in the range 1.35-1.7 g/cm³.

In one embodiment, the tap density is in the range 1.1-1.8 g/cm³. In one embodiment, the tap density is in the range 1.05-1.7 g/cm³. In one embodiment, the tap density is in the range 1.1-1.5 g/cm³. In one embodiment, the tap density is in the range 1.2-1.4 g/cm³. In one embodiment, the tap density is in the range 1.25-1.35 g/cm³.

The relation between the tap density and the BET surface area has turned out to be of importance. In general, a high tap density is desired because it can give batteries with a high energy density, however also the conductivity for electrons and ions moving in and out of the material have to be considered as well in order to give a well-performing battery. It turns out that the ability for ions to diffuse or move in and out of the material to a large extent is related to the BET surface area of the material. Thus, the relation between the BET surface area and the tap density is of importance for the material. For this particular material the BET surface area A is related to the tap density p with the formula

$$A \geq 420 - 262 ρ$$

In the formula the BET surface area A is expressed in m²/g and measured according to ISO 9277:2010. The tap ρ is expressed in g/cm³ and as measured according to as measured using the method described by Carson et al in ASM Handbook, Volume 7: Powder Metal Technologies and Applications P. W. Lee, Y. Trudel, R. Iacocca, R. M. German, B. L. Ferguson, W. B. Eisen, K. Moyer, D. Madan, and H. Sanderow, editors, p 07-301 (1998). Thus the BET surface area (A) is 420-262p or higher.

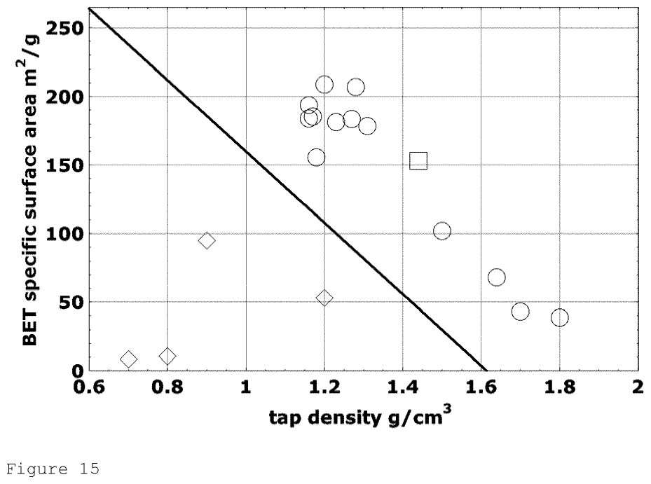

The BET surface area versus the tap density is plotted in FIG. 15 together with comparative data from WO 2008/114667 and JP 5400607.

In one embodiment, the calcined powder comprise at least one selected from the group consisting of carbon nanotubes, carbon nanofibers, and carbon nanoparticles. The nanotubes, nanofibers, and nanoparticles comprise conductive carbon. The diameter of a carbon nanotube is in the order of magnitude of nanometers. Carbon nanofibers are cylindrical nanostructures of carbon with graphene layers arranged as stacked cones, cups or plates. Carbon nanoparticles are particles of carbon where the diameter is up to 100 nm. Graphene flakes up to a size of about 100 nm are acceptable. It has turned out that larger graphene flakes are unsuitable since they have a tendency to wrap around the primary particles and thereby hamper the transport of ions, which can reduce the performance of a battery. Carbon nanofibers and carbon nanotubes as well as carbon nanoparticles do not have this disadvantage. The conducting carbon is In one embodiment, added before the spray drying so that the secondary particles comprise the carbon mixed with the primary particles. In an alternative embodiment, the conducting carbon is added after the spray drying. In the latter embodiment, the conducting carbon is between the secondary particles.

In one embodiment, the weight ratio of conducting carbon to primary particles is in the range 0.1-20% by weight carbon to primary particles. The conducting carbon should give good conducting properties, but should not take up too much of the total weight of the finished battery in order to allow a high fraction of active TiO₂ material.

In one embodiment, less than 10% of the number of atoms of Ti in the calcined powder is substituted by at least one selected from the group consisting of Zr, Nb, Ta, Hf, Cr, Fe, Mo, V, W, In, Sn, and Ta. In one embodiment, less than 10% of the number of atoms of Ti in the calcined powder is substituted by Zn. The advantage of adding dopants is to improve the conductivity of the material.

In one embodiment, less than 10% of the number of atoms of O in the calcined powder is substituted by at least one selected from the group consisting of N, P, C, S, and F. Replacing O in the structure improves the conductivity.

For the substitution of Ti and O respectively the degree of substitution is calculated as a fraction of atoms of Ti or O which are substituted. A certain number of atoms are replaced by other atoms and the percentage is calculated based on the number of substituted atoms.

The secondary particles are essentially spherical due to the spray drying. Since the secondary particles are essentially spherical they flow fairly easily. Since the primary particles are spherical the powder has a good flowability which can be measured by a tilt angle test. The secondary particles according to the invention can be distinguished by a higher flowability compared to particles, which have not be spray dried or jet milled. Actually, the angle of repose is a good and practical measure of the sphericity. More spherical particles give a lower angle of repose.

In one embodiment, the secondary particles have a size in the interval 1-50 μm. By “the size of the secondary particles” is meant the average size of the secondary particles. This is measured according to the following. First, the size distribution for the particles is measured according to ISO 19749:2023, then the average size is calculated according to ISO 9276-2:2014 using the method of moments. In other embodiments the secondary particle size is in the interval 0.2-50 μm, 0.2-10 μm, 0.5-50 μm, 0.5-1.5 μm, 2-20 μm as measured as described above.

The primary particles can be coated with at least one element selected from Zn, Al and Si. The primary particles can be coated before agglomeration into secondary particles so that the entire primary particles are coated. Alternatively, the entire secondary particles can be coated when the secondary particles are made of the primary particles. The latter embodiment implies that accessible surface of the primary particles are coated. The latter embodiment also implies that a part of the surfaces of the primary particles are coated since the primary particles are in contact with each other on certain contact points. If the secondary particles are coated a part of the surfaces of the primary particles in the interior of the secondary particles are accessible through the pores in the secondary particles, i.e. the pores between the primary particles. The coating of the primary particles means that the surface of the primary particles comprise at least one compound or element.

In one embodiment, at least a part of the surfaces of the primary particles comprise at least one selected from the group consisting of Zn, Al, Si, Zr, Y, Sn, and oxides thereof. The wording that the surface of a particle comprises for instance Zn means that Zn is on the surface of the particle.

An advantage of a coating with an element selected from Zn, Al, Si, Zr, Y, Sn, and oxides thereof is that the surface becomes less reactive, which is an advantage when the material is used in a battery electrode. Various reactions in a finished battery electrode is thus decreased, which is an advantage. In the primary particles, there are typically more reactive groups at the terminations of the material. These reactive groups become less reactive if there are atoms of Zn, Al, and/or Si at the terminations instead.

Regarding the method for applying the coating the primary particles are in one embodiment subjected to conditions so that negative charges form at the surface. Typically, the negative charges are associated with H⁺ or Na⁺ ions depending on the ions in the surrounding. Ions of Zn, Al, and/or Si are added and the positive ions will at least so some extent be associated with the negative charges on the surface of the primary particles. Thus, at least a part of the surfaces of the primary particles comprise at least one selected from the group consisting of Zn, Al, Si, Zr, Y, Sn, and oxides thereof.

Also other methods of coating the primary particles are encompassed. For instance the primary particles can be coated with CVD, plasma coating or solution coating.

In one embodiment, at least a part of the surfaces of the primary particles are coated by subjecting the primary and/or secondary particles to conditions so that at least a part of titaniumdioxide group at the surfaces of the primary particles becomes negatively charged and thereafter adding ions of at least one element selected from Zn, Al, Si, Zr, Y, Sn, and oxides thereof so that the ions bind to the surfaces, wherein the step is performed at any point from before step d) to after step h).

The coating i.e. the addition of ions can be performed at any point from when the primary particles are formed to treating the formed secondary particles.

It has been discovered that by carefully selecting certain ranges for a number of parameters an unexpectedly good anode material for Li-batteries can be obtained. In particular, it has turned out that an increased tap density gives a number of unexpected advantages, while the transport of for instance ions in the material still is good so that the performance of the battery is good.

Regarding the mesopore volume, it should be noted that too small a volume will impede the transport of Li-ions in the mesopores, whereas too high a volume will impair the energy density of the finished battery.

Regarding the mesopore size, too small a size will impair the transport of Li-ions in the mesopores, whereas too high a mesopore size will not give a good energy density of the finished battery.

The shape of the mesopores is also important, since a highly variable mesopore shape can give narrow collars impeding lithium transport and uneven lithium transport properties, uniform mesopore shape can give the opposite. The inventors have discovered that the present manufacturing method gives an excellent uniformity of the material so that both the primary particles, the mesopores, the secondary particles and the macropores are very uniform with very little variation across the powder. This allows a high tap density while ion transport through the material still is good.

Regarding the size of the primary particles too large a size will restrict the transport of Li-ions inside the primary particles and give less realized capacity. A small crystal size is thereby better down to a lower limit of about 5 nm. A size up to 20 nm is acceptable. In one embodiment, the size of the primary particles is 5-20 nm. In an alternative embodiment, the size of the primary particles is 5-15 nm. In an alternative embodiment, the size of the primary particles is 5-10 nm. In an alternative embodiment, the size of the primary particles is 5-7 nm.

Regarding the shape of the primary particles, the shape should preferably be uniform, which will give a more uniform transport of Li-ions in the material and also ensure an efficient packing of the primary particles resulting in a higher energy density. For the primary particles, a packing efficiency of about 50% or more has turned out to be satisfactory. In one embodiment, the packing efficiency is in the interval 45-55%. This packing is a bit from the theoretical limit for close packed spheres indicating that it can be tolerated that the primary particles are slightly non-spherical, i.e. that they deviate a bit from perfect spheres.

For the primary particles it is preferred that they have a high content of crystalline material and a low content of amorphous material. Higher crystallinity results in less trapping/impeding of lithium and results in relatively faster transport than with higher amorphous content and closer to theoretical capacity and higher first cycle efficiency (ie lower irreversible lithium trapping).

The secondary particles of primary particles become spherical and uniform because of the spray drying used during the manufacture. It is an advantage that the secondary particles are spherical since it gives a number of technical benefits. First, the uniformity of the powder improves so that the properties of the powder is the same across a volume of the material. The spherical shape also makes the powder flow better so that it is easier to pack in a uniform way in an anode material. Another advantage is that the spherical shape facilitates the making of theoretical predictive models of the performance of a battery powder. Irregular non-spherical secondary particles would be much more difficult to model and simulate.

The degree of spherical shape is determined by the flowability of the powder, where more perfect spheres give a lower angle of repose. The powder has an angle of repose of 28.5° or less. The angle of repose is measured according to the fixed base cone method described by Carlson et al in ASM Handbook, Volume 7: Powder Metal Technologies and Applications P. W. Lee, Y. Trudel, R. Iacocca, R. M. German, B. L. Ferguson, W. B. Eisen, K. Moyer, D. Madan, and H. Sanderow, editors, p 287-301 (1998). In one embodiment, the powder has an angle of repose of 27° or less. In one embodiment, the powder has an angle of repose of 28° or less. In one embodiment, the powder has an angle of repose of 29° or less. In one embodiment, the powder has an angle of repose of 30° or less. In one embodiment, the powder has an angle of repose of 31° or less. In one embodiment, the powder has an angle of repose of 32° or less. In one embodiment, the powder has an angle of repose of 33° or less. In one embodiment, the powder has an angle of repose of 34° or less.

When a slurry for manufacturing of the anodes is made a binder is added to the powder. Preferably, the amount of active titanium dioxide should be maximized. Regarding the amount of binder and amount of conductive carbon they should be as necessary to keep the properties of the material as desired but not unnecessary high.

When a slurry for manufacturing of the anodes is made a conducting carbon is also added to the powder in one embodiment. Also in this case the amount of active titanium dioxide should be maximized. Regarding the amount of conducting carbon it should be as necessary to keep the properties of the material as desired but not unnecessary high. When conducting carbon in the form of nanoparticles, nanotubes and/or nanofibers is added during the manufacture of the calcined powder, then it is In one embodiment, added in an amount of 1-2 wt % based on the entire powder composition.

It has turned out that the components in the electrolyte are important in relation to the pore size. In the electrolyte, the Li-ions form complexes or become solvated and depending on the composition of the electrolyte these solvated Li-ions have different size. If the solvated Li-ion is a large complex, then the mesopore size should be larger in order to facilitate efficient transport of the Li-ions. The pore size should be larger than the apparent diameter of the solvated Li-ions to give no or only little mobility reduction of Li-ions, but the pore size should not be too large so that the density of the material is reduced to such an extent so that the energy density of the finished battery becomes too low. The mesopore size should be adapted to the intended electrolyte/solvent composition in the finished battery.

In the second aspect there is provided a battery anode for at least one selected from the group consisting of a lithium ion battery and a sodium ion battery manufactured as described above.

In one embodiment, the anode comprises at least one selected from the group consisting of lithium titanium oxide (LTO), titanium dioxide in bronze phase (TiO₂ (B)).

Certain advantages can be achieved by combining the powder according to the invention with other materials.

An addition of LTO results in higher battery voltages but is typically more expensive than the present powder. Combining these can give options for tailoring cost to voltage performance where certain applications require it. This also allows more flexibility of the source for making anodes

LTO has larger internal lithium mobility. Therefore, adding LTO to the present powder may boost the overall lithium mobility per unit anatase, thus making more efficient use of the material than without LTO

An ideal structure might minimize LTO to increase mobility per unit anatase—e.g. by making a continuous or network of LTO in between the primary particles in the powder.

An addition of TiO₂ in bronze phase, TiO₂ (B) also gives certain advantages. TiO₂ (B) allows a higher battery voltage than the present powder, and TiO₂ (B) can practically achieve higher capacities. Combining these can give tailored voltages and capacities.

It also to achieve combined advantages by combining addition of LTO and TiO₂ (B).

In one embodiment, the anode comprises at least one selected from the group consisting of titanium oxide and niobium oxide.

In the third aspect there is provided a battery cell manufactured as described above.

In the fourth aspect there is provided a battery pack manufactured as described above.

In one embodiment, the battery pack further comprising a control system comprising:
a. a temperature sensor adapted to measure the temperature of the battery pack,
b. a programmable microcontroller communicatively coupled to the temperature sensor, the microcontroller being configured to:
   receive a measured temperature of the battery pack,
   control the temperature of the battery pack based on the measured temperature to maintain the temperature of the battery pack within a predetermined temperature range during charging and/or discharging.

By having such a control system in the battery pack, it is possible to achieve certain advantages, for instance controlling the temperature during charging.

In one embodiment, the control system further comprises a temperature control unit comprising at least one of i) a heater and ii) a cooler in thermal contact with the battery pack; and the microcontroller is configured to control the temperature of the battery pack by controlling operation of the temperature control unit. By having such a temperature control unit there are further possibilities of controlling the temperature of the battery pack.

In one embodiment, the microcontroller is adapted to control the temperature of the battery pack by controlling a charge/discharge current of the battery pack. As an alternative to heating by a heater, i.e. a temperature control unit, it is possible to heat the battery pack by the current in the battery during charge or discharge. Due to the internal resistance of the battery, heat will be generated. Such heat can contribute to the heating so that an external heating can be decreased or even eliminated.

In one embodiment, the microcontroller is adapted to maintain the temperature of the battery pack within a range of 30 to 35° C. during charging the battery pack. It has unexpectedly been found that if the battery is charged at a temperature in the interval of 30 to 35° C., then it is possible to achieve a higher total charge in the battery compared to other temperatures. This higher charge remains after charging even if the temperature is changed to a temperature outside the interval after the charging.

In the fifth aspect there is provided a method for manufacturing a calcined powder, the method comprising the steps of:
a. providing at least one titanic acid with the general formula [TiOₓ(OH)₄₋₂ₓ]ₙ and soluble in at least one selected from the group consisting of TiOCl₂, TiCl₄, and HCl, and dissolving it in a solution comprising at least one selected from the group consisting of TiOCl₂, TiCl₄, and HCl, wherein the pH of the solution is lower than 1,
b. heating to a temperature in the interval 68-110° C., wherein the heating is performed with at least 0.3° C./min,
c. holding the temperature in the temperature 68-110° C. interval during 1-180 minutes, during stirring to form a dispersion comprising primary nanoparticles comprising anatase,
d. cooling the dispersion,
e. adjusting the ion content of the dispersion comprising primary nanoparticles
f. optionally treating the dispersion to neutralize the dispersion to a pH in the range from 4.5 to 5.5,
g. spray drying the dispersion to obtain a powder, wherein the powder after step g) comprises secondary particles comprised of primary particles,
h. drying the powder and then calcining the powder in a temperature in the range 300-650° C. to obtain a calcined powder comprising secondary particles comprised of primary particles,
   wherein the powder is washed in water to decrease the content of ions in the powder at least before or after step h).

In the general formula [TiOₓ(OH)₄₋₂ₓ]ₙ x and n are integers so that the general formula expresses a titanic acid. Examples of titanic acids include but are not limited to x=1, which gives Metatitanic acid (H₂TiO₃) and x=0 which gives Orthotitanic acid (H₄TiO₄). x is thus an integer 0, 1, 2, 3 and so on. n is an integer which expresses how many units there are in the larger structure. n can be a very large integer.

In one embodiment, in step f the pH is in the range 5-6.5. In one embodiment, in step f the pH is in the range 5-6.5. 5.5-7.5.

The steps a-d are manufacture of a dispersion of primary particles comprising TiO₂ in anatase form. The primary particles typically comprise some TiO₂ in bronze form. The primary particles typically comprise a structure with a core or several cores surrounded by at least one layer.

The dispersion of primary particles is spray dried or jet milled to manufacture secondary particles and which secondary particles comprise the smaller primary particles. Between the primary particles there are pores, which facilitate the transport of ions in the Li-ion battery, when the material is utilized in an anode in a battery.

The material is suitably washed to remove undesired ions, which otherwise may reduce the usability as anode material.

In one embodiment, the at least one titanic acid with the general formula [TiOₓ(OH)₄₋₂ₓ]ₙ in step a) is provided by increasing the pH of at least one solution comprising at least one selected from the group consisting of TiOCl₂, and TiCl₄. In another embodiment the at least one titanic acid with the general formula [TiOₓ(OH)₄₋₂ₓ]ₙ in step a) is provided by increasing the pH of at least one solution comprising at least one selected from the group consisting of TiOSO₄, and Ti₂SO₄. Thus it is possible to use TiOSO₄ or Ti₂SO₄ as starting material.

In one embodiment, the titanic acid in step a) is provided as a precipitate, which is recovered and washed.

In one embodiment, the dissolving in step a) is performed with in a solution comprising from 10 to 40 wt % of the at least one selected from the group consisting of TiOCl₂, and TiOSO₄, calculated by weight on the final mixture.

In another embodiment, the dissolving in step a) is performed with a solution comprising from 10 to 30 wt % HCl, calculated by weight on the final mixture.

In one embodiment, the heating in step b) is performed with at least 0.5° C./min.

In one embodiment, the heating in step b) is to a temperature in the interval 68-85° C. If the temperature is higher than the boiling point of the mixture (typically around 100° C.) it is intended that the pressure should be adapted so that the mixture still is liquid.

In one embodiment, the temperature is held during 60-90 minutes during step c).

In one embodiment, the cooling in step d) is performed with at least 1.5° C./min. In one embodiment, the cooling in step d) is performed to a temperature below 50° C.

In one embodiment, at least one of Zr, Nb, Ta, Hf, Cr, Fe, Mo, V, W, In, Sn, and Ta that enter the Ti position in the TiO₂ framework structure is added at any point before the spray drying. The doping increases the capacity of the finished battery.

In one embodiment, at least one of N, P, C, S, and F that substitute for oxygen in the TiO₂ framework structure is added at any point before the spray drying.

In one embodiment, at least one ingredient is added before, during or after the spray drying, the at least one ingredient when calcined forming conductive carbon deposits that enhance the intrinsic electronic conductivity within the particles. This can for instance be any organic compound, which decomposes during calcination and forms conductive carbon. Examples include but are not limited to glycolic acid, and salicylic acid. Such conductive carbon improves the conduction in the anode material thereby improving the performance of the battery.

In one embodiment, the calcination is performed in a reducing atmosphere with at least one reducing additive. In one embodiment the reducing additive is hydrogen gas. In one embodiment the reducing atmosphere comprises hydrogen and argon. In one embodiment the reducing atmosphere comprises about 95 wt % argon and about 5 wt % hydrogen. The term reducing refers to reduction of organic compounds so that they are reduced to carbon. By this method, it is also possible to treat finished particles by adding an organic compound and re-calcining under reducing conditions. The calcination under reducing condition also has an advantage since the abundance of Ti³⁺ ions compared to Ti⁴⁺ ions on the surface of the finished particles increase. This give a better conductivity and a faster charging.

In one embodiment, the calcination temperature and time are utilized to tune crystal characteristics of the particles. The calcination step provides an opportunity to modify the crystal characteristics of primary particles.

In one embodiment, the pore spaces between the primary particles in the particle are tuned by changing the nature of the spray drying so that the spaces form a larger or smaller fraction of the particle, and thereby impact the ion mobility in and out of the spherical particles. The ion mobility in the anode material is an important parameter. The method of first manufacturing primary particles in a dispersion, which subsequently is spray dried to form secondary particles give a further possibility to control the porosity of the particles, i.e. the space between the primary particles. This in turn affects the mobility of ions in the anode material in a battery. During spray drying many different parameters can be adjusted and this affects the pores. Thereby a skilled person can by adjusting the parameters for the spray drying adjust the ion mobility in the anode in the battery.

In one embodiment, the calcination time and temperature are adjusted to alter the nature of the phase balance of the primary particles. In the primary particles there are a number of different phases for the TiO₂ material, such as anatase and so on. The balance between these different phases can be adjusted during the calcination so that there are further possibilities to fine tune the anode material.

In one embodiment, the secondary particles are sorted with respect to their size after the calcination step. In one embodiment, the calcined powder is subjected to a sorting dependent on the size of the secondary particles. In one embodiment the calcined powder is subjected to treatment with at least one selected from the group consisting of a sieve and an air classifier. Both a sieve and an air classifier are established methods to sort particles with respect to their size. The sorting depending on the size has the advantage to be able to obtain an even more narrow size distribution even if the size distribution already is fairly narrow after the spray drying.

In one embodiment, the calcined powder is mixed and/or milled with a liquid, a binder, and a conducting material to obtain a slurry. This slurry is suitable to apply on a conductor and dry it to form an anode. In one embodiment, applied on a metal foil and dried to obtain an anode for at least one selected from the group consisting of a lithium ion battery and a sodium ion battery.

In one embodiment, the secondary particles are separated into different size fractions. The different size fractions may be suitable for different electrode applications.

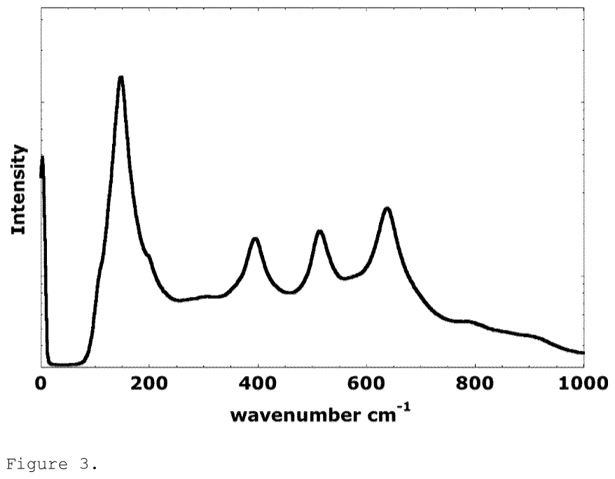

In one embodiment, the anode (1) for a lithium ion battery is combined with a cathode (2), an electrolyte (7) and a casing (4, 5) to form a battery cell. A separator (3) is typically added as well. Such an electrochemical cell is shown in FIG. 3. The conductors for connecting the electrodes (1, 2) to an outer electrical circuit are not shown.

In one embodiment, a plurality of the battery cells are combined to a battery pack.

In one embodiment, a control system is added to the battery pack.

In the sixth aspect there is provided a method of charging or discharging a battery pack as defined above, the method comprising:
receiving a measured temperature of the battery pack,
controlling the temperature of the battery pack based on the measured temperature to maintain the temperature of the battery pack within a predetermined temperature range during charging and/or discharging of the battery pack.

In one embodiment, of the sixth aspect, the method comprising controlling the temperature of the battery pack by controlling operation of a temperature control unit of the battery back.

In one embodiment, the method comprises controlling the temperature of the battery pack by controlling the charge/discharge current of the battery pack. Alternatively or in addition the temperature is In one embodiment, controlled by cooling with air or another cooling medium. Typically there is a need for cooling during charging and/or discharging.

In one embodiment, the method comprises controlling the temperature of the battery pack comprises maintaining the temperature of the battery pack within a range of 30 to 35° C. for charging the battery pack.

In the seventh aspect there is provided a computer-readable medium having stored thereon instructions that, when executed by one or more processors, cause execution of the method of any of claims 30 to 33.

The individual embodiments of each of the different aspects are also applicable to all other aspects and can thus be freely combined unless clearly contradictory. Two or more of all embodiments can thus be freely combined with each other in any combination and are applicable to any aspect. It will be appreciated that two or more selected ones of the mentioned embodiments can be combined.

Other features and uses of the invention and their associated advantages will be evident to a person skilled in the art upon reading the description and the examples.

It is to be understood that this invention is not limited to the particular embodiments shown here. The embodiments are provided for illustrative purposes and are not intended to limit the scope of the invention since the scope of the present invention is limited only by the appended claims and equivalents thereof.

### EXAMPLES

Synthesis of nanoparticulate TiO₂

### Example 1

107.8 kg of commercial titanium oxy chloride solution (TiOCl₂ content=35-36%, HCl content=22-24%) and 53.9 kg of water were neutralized to pH 5.2 using sodium carbonate and sodium hydroxide solutions added over 136 minutes, forming a white precipitate with the temperature controllably raised to 38° C. during neutralisation. 7.5 kg of citric acid and another 248.2 kg of titanium oxy chloride solution were added over 30 minutes bringing pH below zero, the temperature controllably raised to 56.5° C. and re-dissolving the precipitate to obtain a transparent solution. 7.5 kg of acetyl acetone were added and the solution was heated to 81° C. over 57 minutes until a visible precipitate appeared, at which point the temperature was kept constant for 75 minutes before being cooled over 27 minutes to 50° C. thereby obtaining 778 kg of a cooled dispersion.

The ion and TiO₂ content of the cooled dispersion was adjusted to obtain a transparent acidic dispersion of pH 1.1 with approximately 20 weight % TiO₂.

### Example 2

98 kg of commercial titanium oxy chloride solution (TiOCl₂ content=35-36%, HCl content=22-24%) and 48.9 kg of water were neutralized to pH 5.8 using 424.5 kg of a 10% solution of sodium hydroxide added over 90 minutes, forming a white precipitate with the temperature controllably raised to 40° C. and actively maintained. 7.4 kg of citric acid were then stirred in, and to this was added another 228.5 kg of titanium oxy chloride solution over 20 minutes bringing pH below zero, the temperature raised to 50° C. and re-dissolving the precipitate to obtain a transparent solution. 7.5 kg of acetyl acetone were added and the solution was heated to 81° C. over 70 minutes until a visible precipitate appeared, at which point the temperature was kept constant for 75 minutes before being cooled over approximately 30 minutes to 50° C. thereby obtaining 816 kg of a cooled dispersion.

The ion and TiO₂ content of the cooled dispersion was adjusted to obtain a transparent acidic dispersion of pH 1.05 with approximately 18.8 weight % TiO₂.

### Example 3

97.9 kg of commercial titanium oxy chloride solution (TiOCl₂ content=35-36%, HCl content=22-24%) and 49.8 kg of water were neutralized to pH 5.82 using 411.2 kg of a 10% solution of sodium hydroxide added over 120 minutes, forming a white precipitate with the temperature controllably raised to 40° C. and actively maintained. 7.4 kg of citric acid were then stirred in, and to this was added another 228.5 kg of titanium oxy chloride solution over 15 minutes bringing pH below zero, the temperature raised to 50° C. and re-dissolving the precipitate to obtain a transparent solution. 7.4 kg of acetyl acetone were added and the solution was heated to 81° C. over 50 minutes until a visible precipitate appeared, at which point the temperature was kept constant for 75 minutes before being cooled over approximately 40 minutes to 50° C. thereby obtaining 805 kg of a cooled dispersion.

The ion and TiO₂ content of the cooled dispersion was adjusted to obtain a transparent acidic dispersion of pH 1.05 with 17.8 weight & TiO₂.

### Example 4

98 kg of commercial titanium oxy chloride solution (TiOCl₂ content=35-36%, HCl content=22-24%) and 49.5 kg of water were neutralized to pH 7.1 using 423.2 kg of a 10% solution of sodium hydroxide added over 160 minutes, forming a white precipitate with the temperature controllably raised to 35° C. and actively maintained. 7.4 kg of citric acid were then stirred in, and to this was added another 228.2 kg of titanium oxy chloride solution over 20 minutes bringing pH below zero, the temperature raised to 50° C. and re-dissolving the precipitate to obtain a transparent solution. The solution was heated to 80° C. over 70 minutes until a visible precipitate appeared, at which point the temperature was kept constant for 75 minutes before being cooled over approximately 35 minutes to 50° C. thereby obtaining 813.7 kg of a cooled dispersion of density 1.202 g/cm³.

The ion and TiO₂ content of the cooled dispersion was adjusted to obtain a transparent acidic dispersion of approximate pH 0.9 with 19.3 weight % TiO₂ and a density of 1.19 g/cm³.

Neutralization and powder production

### Example 5

The transparent acidic dispersions of example 1 was neutralised to approximately pH 6.5-7 with a 6% NaOH solution at a ratio of approximately 4.5:1 transparent acidic dispersion to base solution, with neutralisation time approximately 30 minutes to produce a neutralised slurry. Spray drying was performed with a Niro Atomizer (Denmark) mini spray drying unit. Spray dryer top entry temperature was 360° C. Spray dryer bottom material exit temperature was set between 127.5±12.5° C. The evaporation rate was 3.5±0.5 liters per hour. The spray dried powder was washed 10-12 volumes of water and dried by rotovapor to obtain approximately 0.9 kg of free flowing powder.

### Example 6

The transparent acidic dispersions of examples 2 was neutralised to pH 6 with a 6% NaOH solution at a ratio of approximately 4.76:1 transparent acidic dispersion to base solution, with neutralisation time approximately 30 minutes to produce a neutralised slurry. Spray drying was performed with a Niro Atomizer (Denmark) mini spray drying unit. Spray dryer top entry temperature was 360° C. Spray dryer bottom material exit temperature was set between 127.5±12.5° C. The evaporation rate was 3.5±0.5 liters per hour. The spray dried powder was washed 10-12 volumes of water and dried by rotavapor to obtain approximately 0.9 kg of free flowing powder.

### Example 7

The transparent acidic dispersion of examples 3 was neutralised to approximately pH 6.5-7 with a 6% NaOH solution at a ratio of approximately 4.5:1 transparent acidic dispersion to base solution, with neutralisation time approximately 30 minutes to produce a neutralised slurry. Spray drying was performed with a Niro Atomizer (Denmark) mini spray drying unit. Spray dryer top entry temperature was 360° C. Spray dryer bottom material exit temperature was set between 127.5±12.5° C. The evaporation rate was 3.5±0.5 liters per hour. The spray dried powder was washed 10-12 volumes of water and dried by rotovapor to obtain approximately 0.9 kg of free flowing powder.

### Example 8

39.7 kg of the transparent acidic dispersion of example 4 was neutralised to approximately pH 7.5 with a 6% NaOH solution at a ratio of approximately 4.5:1 transparent acidic dispersion to base solution, with neutralisation time approximately 30 minutes to produce a neutralised slurry. The slurry was heated to 100° C. in an agitated filter/dryer until a free flowing dry powder was obtained with a temperature of 103° C. and moisture content <20%. The free flowing powder was then heated at 160° C. for approximately 8 hours and cooled to 35-40°. De-ionised water was mixed to achieve a homogeneous slurry that was subsequently filtered through a bottom filter/dryer with stirrer rotation reversed to press the filter cake until no water was removed to obtain a first washed filter cake. Water washing was repeated to obtain a second then third washed filter cake. Washing was continued until a desired chloride value was obtained. The powder was then dried at 80° C. for 8 hours at a drying pressure of 25 mm Hg obtaining a final loss on drying (LOD) of 1.69%, a chloride content of 295 ppm and a tap density of 1.36 g/cm³.

### Calcination

### Example 9

The dried powders from examples 1-8 were dried again at a temperature of 140° C. for 30 minutes followed by 270° C. for 30 minutes and then calcined at a final temperature of 350-600° C. for 15-120 minutes as given in Table 1.

TABLE 1

| | | Final | | Tap | Tap density |
|---|---|---|---|---|---|
| | | temperature | Time | density | uncertainty |
| Example | Sample | ° C. | minutes | cm³/g | cm³/g |
| 7 | A | 350 | 30 | 1.28 | 0.19 |
| 7 | B | 350 | 60 | 1.17 | 0.15 |
| 7 | C | 350 | 90 | 1.16 | 0.15 |
| 7 | D | 350 | 120 | 1.27 | 0.04 |
| 7 | E | 400 | 30 | 1.20 | 0.03 |
| 7 | F | 400 | 60 | 1.16 | 0.11 |
| 7 | G | 400 | 75 | 1.23 | 0.03 |
| 7 | H | 400 | 120 | 1.18 | 0.03 |
| 7 | I | 500 | 30 | 1.25 | 0.04 |
| 7 | J | 500 | 60 | 1.33 | 0.05 |
| 7 | K | 500 | 90 | 1.34 | 0.05 |
| 7 | L | 500 | 120 | 1.50 | 0.05 |
| 7 | M | 600 | 15 | 1.31 | 0.04 |
| 7 | N | 600 | 30 | 1.64 | 0.06 |
| 7 | O | 600 | 60 | 1.70 | 0.06 |
| 7 | P | 600 | 90 | 1.80 | 0.02 |
| 5 | Q | 450 | 60 | 1.22 | 0.01 |
| 6 | R | 450 | 60 | 1.20 | 0.01 |
| 8 | S | 400 | 60 | 1.44 | 0.02 |

### Battery Anode Preparation and Tested

### Example 10

For each anode material A-H and M-S, an anode slurry was made with the calcined powders of example 9 as follows with the following material balances:
0.7 g of TiO₂ secondary particles of example 9
0.2 g Super C 65 carbon black (Imerys®)
0.1 g Kynar® PVDF (polyvinylidene fluoride).

First, PVDF is dispersed at a rate of 5 wt % in NMP to give 2g of binder solution. Then the carbon black is dispersed in the binder solution followed by the TiO₂ secondary particles plus 2.9-3.5g of NMP to obtain the pre-homogenised anode slurry. This slurry is then mixed in a planetary mixer inside a 50 ml jar without any other media at 2000 rpm for 30-60 minutes. The slurry is transferred to a Retch mixer mill MM 200 in a 10 ml jar with a 10 mm stainless stell ball and further homogenised at 25 Hz for 10 minutes.

The homogenized slurries were then coated onto aluminium foil using a K control coater with a meter bar with a 200 μm gap, designed to leave a wet film deposit of 90-115 μm.

After coating the electrode sheets were dried at 80° C. for 3 hours. 14 mm diameter discs were punched from the electrode sheets and were dried for approximately 14 hours at 120° C. under vacuum.

2032 Hoshen coin-cells (9 cells per sample) were assembled using 16 mm Li foil discs as counter electrodes a Celgard 2400 PP separator and total of 70 μL electrolyte (1M LiPF6 in EC/December 1:1 wt.) EC/DEC is ethylene carbonate/diethyl carbonate.

For each sample the nine cells were divided into triplicate sets of three lots of three. One set of three cells were cycled from 1-2.5 V at 0.1 C, another set of three were cycled from 1-2.5 V at 1C and yet another three were cycled at varying charge/discharge rates. For the latter cycling at different rates, the cycles were 2 cycles at 0.1 C, 10 cycles at each of 0.5 C, 1 C, 2 C, 5 C and 10 C and returned for 10 cycles at 0.5 C and finally 2 cycles at 0.1 C. 1 C specific current is here defined as 330 mA/g TiO₂.

From each set of triplicate cells averaged data was extracted.

Preparation of niobium and nitrogen doped anatase

### Example 11

Two niobium doped anatase materials, samples T and U, were prepared using the method of example 4 with the same ratio of input materials, intermediate pH values and temperatures and approximately the same heating and cooling rates. The constant temperature heating after the second addition of TiOCl₂ solution was held at 78° C. for 75 minutes. Masses of 40.90 g and 40.88g of total TiOCl₂ solution were used in T and U respectively. In addition anhydrous 0.042 and 0.33g of NbCl₅ powder was stirred into 6 ml of deionized water and added as a dopant source after the first addition of TiOCl₂ solution in T and U respectively. This corresponds to a rate of 0.1% (T) and 1% (U) atomic ratio of Ti: Nb.

The cooled dispersion obtained after the last heating step lasting 75 minutes was then neutralised to pH 4.5 with 6% NaOH to obtain a slurry. The slurry was then dried at 110° C. to obtain a powder that was subsequently washed with deionized water to remove dissolved ions. The two Nb doped powders were then calcined in the same manner as example 9 with a final temperature of 400° C. for 60 minutes. These two calcined Nb-doped anatase powders were hand ground in a mortar and pestle and then subject to battery testing in the manner of example 10. Capacities at 0.1C heating rate were found to be 210 mAh/g for 0.1% Nb-doped material and 210 mAh/g 1% Nb-doped sample after the 2nd cycle at 0.1 C.

### Example 12

Nitrogen doped samples were prepared in the manner of example 1 except the precipitate after the first neutralization of the titanium source was separated and washed and mixed with thiourea prior to the redissolution and heating steps. Calcination was at 500° C. XRD crystallite size was 20 nm. X-ray photoelectron spectroscopy (XPS) confirmed presence of nitrogen and UV-visible spectra indicated a clear red shift in the absorption and a noticeable yellowing of the powder.

### Example 13

The anatase powders of example 7, and treated in the manner of example 9 but calcined at a final temperature of 450° C. for 60 minutes were mixed with lithium titanate Li₄Ti₅O₁₂ (Custom Cells, Itzehoe, Germany) by grinding in a mortar and pestle at different mass ratios to obtain six mixed powders. These mixed powders contained 100%, 80%, 60%, 40%, 20% and 0% anatase by mass percentage. These mixed powders were then prepared as coin cells in the manner of example 10 and voltage versus capacity curves were generated to show the voltage response on lithiation and delithiation of the mixed materials.

### Angle of Repose

### Example 14

Repose angle is measured according to the method described by Carson et al in ASM Handbook, Volume 7: Powder Metal Technologies and Applications P. W. Lee, Y. Trudel, R. Iacocca, R. M. German, B. L. Ferguson, W. B. Eisen, K. Moyer, D. Madan, and H. Sanderow, editors, p 287-301 (1998). The angle of repose is defined as the angle the surface of an unconstrained pile of powdered TiO₂ makes with a horizontal surface. We used the fixed-base cone method described on page 299 of Carson et al. The powder is allowed to flow through a funnel, which is raised vertically until the heap covers a circular base of fixed size. The tangent of the angle of repose is the ratio of the height to the mean radius of the base of the powder heap.

In each experiment, powders were poured onto a standard office printing paper sheet taped flat on a hard horizontal surface. The powders were previously dried by heating at a maximum temperature of 350° C.-600° C. and then storing in sealed containers after cooling and running experiments at relative humidity values in the range of 20-80%. The powder was poured through a 100 ml plastic funnel, with an opening chosen to give slow flow that did not collapse the peak of the powder pile as the funnel was raised during the experiment. The funnel was kept 2-5 mm above the growing apex of the powder pile. The flow rate meant the powder pile in each experiment was fully poured after approximately 1-2 minutes. Experiments were not counted if the powder apex collapsed at the end of the experiment.

On the paper was printed close spaced, fixed radii concentric rings with radii 3 cm to 10 cm. Three repeat pours were made and in each repeat experiment, the radii were measured at 8 points from overhead photographs and averaged. A single estimate of the height was made using a vertical graduated scale mounted next to the pile and measured using a movable horizontal beam lowered to touch the top of the pile, checking the horizontal with a spirit level. An estimate of the uncertainty was made from the standard deviation of the average radii of the three repeats, accounting for the uncertainty of ±0.25 mm in the individual estimates of radius and an uncertainty of 0.5 mm was used in the estimate of pile height. Angle of repose are given in table 2. The star next to the sample name indicates that the angle of repose was determined for the particular example in table 1, except prior to calcination. We believe the calcination step makes little difference to the angle of repose for a given powder secondary particle comprising 2-20 nm anatase nanoparticles.

### REFERENCE

Carson, et al., in ASM Handbook, Volume 7: Powder Metal Technologies and Applications P. W. Lee, Y. Trudel, R. Iacocca, R. M. German, B. L. Ferguson, W. B. Eisen, K. Moyer, D. Madan, and H. Sanderow, editors, p 287-301.

### COMPARATIVE EXAMPLES

Calcined anatase secondary particles were obtained in the manner of example 1, including neutralization of the transparent acidic dispersion, except the drying was via a paddle dryer. Powders

TABLE 2

| | | | BJH | BJH | BET | XRD |
|---|---|---|---|---|---|---|
| | | Pore | Adsorption | Desorption | Surface | Crystallite |
| | | volume | pore | pore | area | size |
| Example | Sample | cm³/g | size nm | size nm | m²/g | nm |
| 7 | A | 0.26799 | 4.0579 | 3.8509 | 206.89 | 6.18 |
| 7 | B | 0.25540 | 4.3009 | 4.0148 | 185.28 | 6.48 |
| 7 | C | 0.25973 | 4.4081 | 4.0832 | 183.84 | 6.53 |
| 7 | D | 0.25664 | 4.3496 | 4.0648 | 183.61 | 6.18 |
| 7 | E | 0.27863 | 4.1718 | 3.9406 | 209.00 | 6.09 |
| 7 | F | 0.26512 | 4.2880 | 4.0239 | 193.77 | 6.23 |
| 7 | G | 0.25843 | 4.4210 | 4.1264 | 181.38 | 6.48 |
| 7 | H | 0.25330 | 5.0970 | 4.7006 | 155.60 | 7.24 |
| 7 | I | | | | | 6.64 |
| 7 | J | 0.1690 | 5.3896 | 4.7701 | 101.75 | 8.53 |
| 7 | K | | | | | 8.59 |
| 7 | L | | | | | 9.06 |
| 7 | M | 0.23581 | 4.1635 | 3.8817 | 178.52 | 6.64 |
| 7 | N | 0.14375 | 6.8944 | 6.0456 | 68.233 | 12.54 |
| 7 | O | 0.11144 | 8.6925 | 7.4355 | 43.029 | 15.94 |
| 7 | P | 0.12249 | 10.723 | 9.2459 | 38.600 | 17.24 |
| 5 | Q | | | | | |
| 6 | R | | | | | |
| 8 | S | 0.21182 | 4.3292 | 4.0202 | 153.16 | |

(The number of decimals in the measured values do not reflect the accuracy of the measurements, but are merely measured values.)

### Example 15 Tap Density

Tap density is measured according to the method described by Carson et al in ASM Handbook, Volume 7: Powder Metal Technologies and Applications P. W. Lee, Y. Trudel, R. Iacocca, R. M. German, B. L. Ferguson, W. B. Eisen, K. Moyer, D. Madan, and H. Sanderow, editors, p 287-301 (1998). The tap density of a powder is defined as the mass of the powder divided by the volume of the powder after tapping a container containing the powder until the volume of the powder shows no further reduction. We use the hand tapping procedure reported on page 294 of Carson et al., 1998.

In each experiment dry powder were poured gently into a clean and dry 10 ml pyrex graduated cylinders ensuring a level surface, and the initial volume prior to tapping was measured to an accuracy of 0.1 ml and the mass measured to the nearest milligram on a three digit balance. The uncertainty of any mass measurement was estimated to be ±0.005 g mostly due to occasional air currents over the balance.

Tapping was performed by hand tapping the cylinder squarely on 3 layers of absorbent kitchen paper towel placed flat on a rigid solid metal bench top until no further volume reduction occurred. In Carson et al a rubber slap is used, but we believe that 3 layers of absorbent kitchen paper is equal to the rubber slab in Carson et al regarding the achieved effect and measurement results. The tapped volume was measured to an accuracy of half a graduation ≈0.05 ml. The tap density was then calculated by dividing the mass by the tapped volume. An estimate of the uncertainty in the density was made by calculating the density at the extremes of the uncertainty in the separate mass and tapped volume for each sample.

Tap densities were modeled with a sphere packing structural model. The structural model comprises an average spherical spray dried particle with a density directly determined from the pore volume obtained from the nitrogen sorption data for each of the spray dried powders A-L. A density value of 3.8 g/cm³ for titanium dioxide was used. The model uses a 64% volume fraction of secondary particles for the tapped powder pack, a value typically taken as the upper limit value for random close packing (RCP) of spheres by tapping-see references by Torquato et al and Aste et al.
Torquato et al., Is Random Close Packing of Spheres Well Defined? Physical Review Letters. 84 (10) 2064-2067.
Aste et al,. The geometrical structure of disordered sphere packings. Physical Review E 71, 061302.

Crystallite sizes of primary particles shown in Table 2 were determined using x-ray diffraction using the Scherrer equation, and the width of the peak corresponding to the {011} crystallographic diffraction peak. Instrumental broadening was determined using a broadening function determined from the peak widths of spectroscopic UV grade synthetic CaF2 disc ground to a powder interpolated to the position of the {011} anatase peak. A value of 0.94 was used for the K value in the Scherrer equation. Transmission electron microscope imaging confirmed the primary particles are single crystals, therefore we take the crystallite size as a proxy indicator of the primary particle size in the secondary particles.

### Pore Volume, Pore Size and Specific Surface Area

Pore volume, pore size and surface area were determined from nitrogen physisorption isotherms. ISO 9277:2010 describes the measurement of BET surfaces area. Nitrogen adsorption-desorption isotherms were recorded at −196° C. using a Micrometrics ASAP2020 volumetric adsorption analyzer. Samples were treated under dynamic vacuum conditions (<10-5 Torr) at a temperature of 130° C. for 5 h. Specific surface areas were calculated, according to the BET method, from the data recorded at P/P0=0.05-0.15. The total pore volume was calculated at a relative pressure of P/P0 of 0.988. Pore sizes were determined from the isotherm on the adsorption and desorption branches. Pore sizes were determined in the range 1.7-300 nm using the BJH method, using the Halsey equation for thickness and Faas correction within the Micromeritics ASAP2020 V. 4.02 J software and both mesopore size and volumes were measured as described in ISO 15901-2:2006.

TABLE 3

| | | Angle | Angle | Tap | Tap density |
|---|---|---|---|---|---|
| | | of | of repose | density | uncertainty |
| Example | Sample | repose ° | uncertainty ° | cm³/g | cm³/g |
| 7 | A* | 27.8 | 1.5 | 1.24 | 0.01 |
| 7 | D | 27.5 | 2.0 | 1.27 | 0.04 |
| 7 | P | 26.7 | 1.6 | 1.80 | 0.02 |
| 7 | A# | 32.3 | 2.0 | 1.2 | 0.11 |
| 5 | Q* | 27.8 | 2.2 | 1.16 | 0.01 |
| 5 | Q** | 43.6 | 1.0 | 0.69 | 0.01 |
| 6 | R* | 27.6 | 2.2 | 1.24 | 0.05 |
| 6 | R** | 38.3 | 2.5 | 1.25 | 0.01 |
| 8 | S* | 24.2 | 2.2 | 1.39 | 0.01 |
| 8 | S** | 43.2 | 1.0 | 0.9 | 0.11 |
| 16 | V** | 41.8 | 1.3 | 1.33 | 0.02 |
| 16 | V* | 36.7 | 4.0 | 1.33 | 0.02 |
| 17 | W* | 27.5 | 1.1 | 1.15 | 0.01 |

*denotes the sample was obtained in the same means as the example but was not calcined and remained unground
**denotes the sample was obtained in the same means as the example but was not calcined and was jet milled in the manner of example 16
#denotes the sample was obtained during the start up phase of spray drying in the manner described in examples 5-7, where the powder did not come out of the spray dryer as a free flowing powder

### Example 16

A transparent acidic dispersion was made by mixing two batches produced in the manner of example 1, with all production parameters for each batch closely approximating the parameters in example 1 including the reactants, the intermediate and final states and final masses. A portion of the mixed batch was neutralised in the same manner as example 4 in the chamber of a glass lined reactor under stirring until pH 6.5-7 monitoring pH for 10 minutes post NaOH addition for stabilization. Portions of the resulting slurry were partially dried in a paddle dryer at mid speed stirring (17-21 rpm) and heating to 100° C. collecting evaporated water in a condenser. After much of the initial water was driven off more of the neutralised slurry was added and this process repeated a fourth time and the drying slurry in the paddle dryer was dried until a free flowing powder of 103° C. was achieved and a powder humidity was less than 20%. Cooling to 20-30° C. was followed by collection. 2.5 kg of this powder was washed several times, each time with 25 liters of deionised water on a static filter in the upper part of the same unit until a desired chloride level was achieved. The wet filter cake was transferred back to the dryer section. Powder humidity was tested and the powder was dried at 110° C. with paddles rotating at 17-21 rpm when the humidity level reached 3%. At this point the powder was cooled to 30-35° C. The coarse powder was collected-sample V* of Table 3. The powder was then ground using a jet mill to a d50 in the range of 5-10 microns-sample V** of Table 3.

### Example 17

A transparent acidic dispersion was made in the manner of example 3, with all production parameters closely approximating the parameters in example 4 including the reactants, the intermediate and final states and final mass. A portion of this dispersion was spray dried, washed and dried in the manner of example 7. This is sample W of Table 3.

### Example 18 LH-15-500-2H and LH-15-600-2H

To obtain a 10 at % Nb doped sample, 3.33 g of Niobium (V) Chloride 98+ from Sigma and 6 mL of deionized water, were added to 12.28 g of commercial titanium oxychloride solution (TiOCl₂ content=35-36%, HCl content=22-24%). The reaction mixture was neutralized to pH 4.58 using a 2.5 M solution of sodium hydroxide (NaOH) added over 43 minutes, forming a white precipitate with the temperature controllably raised to 34° C. during neutralization. The reaction mixture was under stirring for 10 min before adding 28.58 g of titanium oxychloride to obtain a clear solution with pH below zero. 0.99 g of citric acid dissolved in 2 mL deionized water were added to the clear solution, and then it was heated, in a water bath, to the range of 78-81° C., over 41 minutes, until a visible precipitate appeared, at which point the temperature was kept constant for 75 minutes before being cooled in ice bath to 25° C. The cooled dispersion was transferred to a measuring cylinder and left to settle overnight.

The supernatant was removed, and the settled fraction was neutralised with 2.5 M solution of NaOH, up to pH 4.83. The neutralised dispersion was set to dry in air at 110° C. for 2 days, and the remaining powder was then grinded and washed with deionised water to reduce chloride content.

The washed powder was fully dried in air at 110° C. and then calcined, in air, at 500° C. for 2 hours, for example LH-15-500-2H and at 600° C. for 2 hours, for example LH-15-600-2H, following the steps described in Example 9.

### Example 19 GR-22-500-2H

To obtain a 10 at % Zn doped sample, 0.85 g of Zinc Chloride 98+ from Sigma and 3 mL of deionized water, were added to 6.16 g of commercial titanium oxychloride solution (TiOCl2 content=35-36%, HCl content=22-24%). The reaction mixture was neutralized to pH 4.65 using a 2.5 M solution of sodium hydroxide (NaOH) added over 25 minutes, forming a white precipitate with the temperature controllably raised to 35° C. during neutralization. The reaction mixture was under stirring for 10 min before adding 14.1 g of titanium oxychloride to obtain a clear solution with pH below zero. 0.45 g of citric acid dissolved in 1 mL deionized water were added to the clear solution, and then it was heated, in a water bath, to the range of 75-80° C., over 30 minutes, until a visible precipitate appeared, at which point the temperature was kept constant for 75 minutes before being cooled in ice bath to 25° C. The cooled dispersion was transferred to a measuring cylinder and left to settle overnight.

The supernatant was removed, and the settled fraction was neutralised with 2.5 M solution of NaOH, up to pH 4.63. The neutralized dispersion was set to dry in air at 110° C. for 5 days, and the remaining powder was then grinded and washed with deionised water to reduce chloride content.

The washed powder was fully dried in air at 110° C. and then calcined, in air, at 500° C. for 2 hours, following the steps described in Example 9.

### Example 20 GJ-02-500-2H

To obtain a 10 at % Fe doped sample, 1.09 g of FeCl₃ 97% from Sigma and 3 mL of deionized water, were added to 6 g of commercial titanium oxychloride solution (TiOCl₂ content=35-36%, HCl content=22-24%). The reaction mixture was neutralized to pH 4.65 using a 2.5 M solution of sodium hydroxide (NaOH) added over 13 minutes, forming a white precipitate with the temperature controllably raised to 35° C. during neutralization. The reaction mixture was under stirring for 10 min before adding 14.48 g of titanium oxychloride to obtain a clear solution with pH below zero. 0.45 g of citric acid dissolved in 1 mL deionized water were added to the clear solution, and then it was heated, in a water bath, to the range of 78-81° C., over 48 minutes, until a visible precipitate appeared, at which point the temperature was kept constant for 75 minutes before being cooled in ice bath to 25° C. The cooled dispersion was transferred to a measuring cylinder and left to settle overnight.

The supernatant was removed, and the settled fraction was neutralized with 2.5 M solution of NaOH, up to pH 4.6. The neutralized dispersion was set to dry in air at 110° C. for 2 days, and the remaining powder was then grinded and washed with deionised water to reduce chloride content.

The washed powder was fully dried in air at 110° C. and then calcined, in air, at 500° C. for 2 hours, following the steps described in Example 9.

### Example 21 GJ-01-500-2H

To obtain a 10 at % Sn doped sample, 2.19 g of SnCl₄*5H₂O from Sigma and 3 mL of deionized water, were added to 6.31 g of commercial titanium oxychloride solution (TiOCl₂ content=35-36%, HCl content=22-24%). The reaction mixture was neutralized to pH 4.7 using a 2.5 M solution of sodium hydroxide (NaOH) added over 54 minutes, forming a white precipitate with the temperature controllably raised to 32° C. during neutralisation. The reaction mixture was under stirring for 10 min before adding 14.25 g of titanium oxychloride to obtain a clear solution with pH below zero. 0,47 g of citric acid dissolved in 1 mL deionized water were added to the clear solution, and then it was heated, in a water bath, to the range of 78-81° C., over 70 minutes, until a visible precipitate appeared, at which point the temperature was kept constant for 95 minutes before being cooled in ice bath to 25° C. The cooled dispersion was transferred to a measuring cylinder and left to settle overnight.

The supernatant was removed, and the settled fraction was neutralized with 2.5 M solution of NaOH, up to pH 4, 63. The neutralized dispersion was set to dry in air at 110° C. for 2 days, and the remaining powder was then grinded and washed with deionized water to reduce chloride content.

The washed powder was fully dried in air at 110° C. and then calcined, in air, at 500° C. for 2 hours, following the steps described in Example 9.

### Example 22 JK-01-500-2H

To obtain a 10 at % Mo doped sample, 2.15 g of (NH₄)₆Mo₇O₂₄*4H₂O from Sigma and 6 mL of deionized water, were added to 12.23 g of commercial titanium oxychloride solution (TiOCl2 content=35-36%, HCl content=22-24%). The reaction mixture was neutralized to pH 5,15 using a 2.5 M solution of sodium hydroxide (NaOH), forming a white precipitate. The reaction mixture was under stirring for 10 min before adding 28, 56 g of titanium oxychloride to obtain a clear solution with pH below zero. 0,935 g of citric acid dissolved in 2 mL deionized water were added to the clear solution, and then it was heated, in a water bath, to the range of 78-81° C., over 40 minutes, until a visible precipitate appeared, at which point the temperature was kept constant for 75 minutes before being cooled in ice bath to 25° C. The cooled dispersion was transferred to a measuring cylinder and left to settle overnight.

The supernatant was removed, and the settled fraction was neutralized with 2.5 M solution of NaOH, up to pH 5.11. The neutralized dispersion was set to dry in air at 110° C. for 2 days, and the remaining powder was then grinded and washed with deionized water to reduce chloride content.

The washed powder was fully dried in air at 110° C. and then calcined, in air, at 500° C. for 2 hours, following the steps described in Example 9.

### Example 23 JK-04-500-2H

Comparative, without Spray Drying

To obtain a 8 at % Ta doped sample, 4.37 g of TaCl₅ from Sigma dissolved in 10 mL of ethanol, was added to 12.26 g of commercial titanium oxychloride solution (TiOCl₂ content=35-36 wt %, HCl content=22-24%). The reaction mixture was neutralized to pH 4.50 using a 2.5M solution of sodium hydroxide (NaOH) added over 47 minutes, forming a white precipitate with the temperature controllably raised to 38° C. during neutralization. The reaction mixture was under stirring for 10 min before adding 33.82 g of titanium oxychloride to obtain a clear solution with pH below zero. After stirring for 1 hour, 0.987 g of citric acid dissolved in 1 mL deionized water was added to the clear solution, and stirred for 20 min. Then the reaction mixture was heated in a water bath to the range of 78-81° C., over 40 minutes, until a visible precipitate appeared, at which point the temperature was kept constant for 75 minutes before being cooled in ice bath to 25° C. The cooled dispersion was transferred to a measuring cylinder and left to settle overnight.

The supernatant was removed, and the settled fraction was neutralized with 2.5M solution of NaOH, up to pH 4.69. The neutralized dispersion was set to dry in air at 110° C. for 2 days, and the remaining powder was then ground and washed with deionised water to reduce chloride content.

The washed powder was fully dried in air at 110° C. and then calcined, in air, at 500° C. for 2 hours.

### Nitrogen Doped Samples:

### Example 24 GR-31

### Synthesis Comments:

T-2022-1-B1: 8.8 g (separated in 2 crucibles)
Urea solution: 0.369 g in 4 mL DI water
Crucible 2:4.36 g powder+2 mL solution

The solution was simply poured on top of the powder in the most uniform way possible. The solution was mixed in the powder with a spatula. The powder finished with a slightly wet sand consistency. The mixture was left to rest for 1 day before calcination.
Urea solution 2:1.53 g+4 mL DI water

The solution was simply poured on top of the powder in the most uniform way possible. The solution was mixed in the powder with a spatula. After the addition of the urea solution a milky dispersion was formed. The mixture was left to rest for 1 hour before calcination.

Sample comments: After calcination at 500° C. 2 hours, the powder came out with a very subtle tone of beige.

### Example 25 GL-06-urea-400-1h

To obtain a N-doped sample by incipient wetness method, firstly TiO₂ was synthesised in laboratory scale as follows:

6 mL of deionized water, were added to 12.29 g of commercial titanium oxychloride solution (TiOCl₂ content=35-36%, HCl content=22-24%). The reaction mixture was neutralized to pH 5.0-5.5 using a 2.5 M solution of sodium hydroxide (NaOH) added over 40 min, forming a white precipitate with the temperature controllably raised to 31° C. during neutralisation. The reaction mixture was under stirring for 10 min before adding 28.0 g of titanium oxychloride to obtain a clear solution with pH below zero. 0.92 g of citric acid dissolved in 2 mL deionized water were added to the clear solution, and then it was heated, in a water bath, to the range of 78-81° C., over 43 minutes, until a visible precipitate appeared, at which point the temperature was kept constant for 75 minutes before being cooled in ice bath to 25° C. The cooled dispersion was transferred to a measuring cylinder and left to settle overnight.

The supernatant was removed, and the settled fraction was neutralised with 2.5 M solution of NaOH, up to pH 4.83. The neutralised dispersion was set to dry in air at 110° C. for 2 days, and the remaining powder was then grinded and washed with deionised water to reduce chloride content.

To obtain the doped sample, 1 g of this described powder was soaked in a solution of 0.377g of urea (298% Fluka) in 2 mL DI. After 1 hour the mixture was calcined at 400° C. for 1 hour.

The powder had a light yellow color after calcination.

A Raman analysis gave that it was a pure anatase spectrum.

### Example 26 GR-30

### Synthesis Comments:

T-2022-1-B1: 8.8 g (separated in 2 crucibles)
Urea solution: 0.369 g in 4 mL DI water
Crucible 1:4.04 g powder+2 mL solution
Crucible 2:4.36 g powder+2 mL solution

The solution was simply poured on top of the powder in the most uniform way possible. The solution was mixed in the powder with a spatula. The powder finished with a slightly wet sand consistency. The mixture was left to rest for 1 hour before calcination.

### Sample Comments:

After calcination at 500° C. 2 hours, the powder came out white. We were expecting a yellow colour based on previous sample (GL-06-urea-400-1h).

The color would be an indication of doping. It is worth noting that the absence of a visual colour aspect change does not necessarily mean the sample was not doped. In an attempt to get a yellow-ish product, crucible 2 was immersed again in more urea (see sample GR-31).

### Example 27 GF-01

3 mL of deionized water, were added to 6.12 g of commercial titanium oxychloride solution (TiOCl₂ content=35-36%, HCl content=22-24%). The reaction mixture was neutralized to pH 5.65 using a 2.5 M solution of sodium hydroxide (NaOH) added over 20 min, forming a white precipitate with the temperature controllably raised to 32° C. during neutralization. The reaction mixture was under stirring for 10 min before adding 14.06 g of titanium oxychloride to obtain a clear solution with pH below zero. 0.45 g of citric acid dissolved in 1 mL deionized water were added to the clear solution, and then it was heated, in a water bath, to the range of 72-78° C., over 33 minutes, until a visible precipitate appeared, at which point the temperature was kept constant for 180 minutes before being cooled in ice bath to 25° C. The cooled dispersion was transferred to a measuring cylinder and left to settle overnight.

The supernatant was removed, and the settled fraction was neutralised with 2.5 M solution of NaOH, up to pH 4.65. The washed powder was fully dried in air at 110° C. and then calcined, in air, at 400° C. for 1 hour, following the steps described in Example 9.

### Example 28 GR-23

3 mL of deionized water, were added to 6.10 g of commercial titanium oxychloride solution (TiOCl₂ content=35-36%, HCl content=22-24%). The reaction mixture was neutralized to pH 4.6 using a 2.5 M solution of sodium hydroxide (NaOH) added over 20 min, forming a white precipitate with the temperature controllably raised to 30° C. during neutralisation. The reaction mixture was under stirring for 10 min before adding 14.10 g of titanium oxychloride to obtain a clear solution with pH below zero. 0.45 g of citric acid dissolved in 1 mL deionized water were added to the clear solution, and then it was heated, in a water bath, to the range of 95-105° C., over 69 minutes, until a visible precipitate appeared, at which point the temperature was kept constant for 75 minutes before being cooled in ice bath to 25° C. The cooled dispersion was transferred to a measuring cylinder and left to settle overnight.

The supernatant was removed, and the settled fraction was neutralized with 2.5 M solution of NaOH, up to pH 4.74. The washed powder was fully dried in air at 110° C. and then calcined, in air, at 400° C. for 1 hour, following the steps described in Example 9.

Example 29, anode AT1 produced via aqueous processing using carboxy methyl cellulose (CMC) as a binder and pH adjustment with acetic acid

A pure anatase spray dried powder was obtained in the manner of example 5, that was subsequently calcined at 500° C. for 2 hours in air. The powder so obtained was then sieved through a 25 micron mesh and the material that came through the mesh was used in this example. The average particle size was 15 microns and the angle of repose was below 30°. The tap density was 1.5 g/cm³. The pH of the powder dispersed in water was adjusted to below <9.5.

2.76 g of dried powder was mixed together with 0.152 g of carbon black, and 6.06 g of a 1.0 wt % solution of Daicel CMC 2200 in H₂O. These were mixed in a TMAX Battery Equipment TMAX-ITT-300S centrifugal mixer in a multi-step program, with each step being 20 mins mixing at 2000 rpm and 1 minute degassing under vacuum. In step 1, binder, acetic acid and carbon black were mixed, in step 2 half of the active material was added to this and in step 3 the remainder of the active material was added. The total mass of solids was 3.00 g. The slurry mass was 8.98g. After mixing the slurry was coated using a 200 micron gap size applicator bar onto a copper foil, and subsequently dried at 60° C. for 3 hours to obtain a coating composition as follows 91.95 wt % TiO₂, 5.05 wt& carbon black and 3.00 wt % CMC. Electrodes were made by punching 14 mm diameter circular discs of the casted anode material on copper, with an area of 1.5394 cm² and with a total active mass of approx. 0.011g. These were dried in a vacuum at 120° C. for >12 hrs. The total mass of the electrode plus current collector was approx. 0.020g. The areal active mass was approx. 0.007 g/cm².

Half cell coin cells were assembled using these anodes together with a polypropylene separator and a 16 mm lithium disc cut to fit into a 2032 coin cell. 70 μl of electrolyte was used, of composition 1M LiPF₆ in 50:50 EC: DEC. The coin cell was then cycled according to a rate programme whereby a theoretical capacity for the active material of 330 mAh/g was used to set the currents in terms of C rates. The following sequence of currents was then applied to the coin cell to assess the rate capability of the cell: 0,1C 2 full lithiation/delithiation cycles; 0.5C 10 cycles; 1C 10 cycles; 2C 10 cycles; 5C 10 cycles; 10C 10 cycles then followed by 0,5C again for 10 cycles and 2 cycles at 0.1 C.

The following results were obtained during rate testing for anode AT1 performed in triplicate on three separate half-cell coin cells, averaging the data:
First cycle efficiency: 91%; Capacities—0.1C 195 mAh/g; 0.5C 162 mAh/g; 1C 132 mAh/g; Recovered capacity at 0.5 C was 159 mAh/g, and at 0.1C was 194 mAh/g.

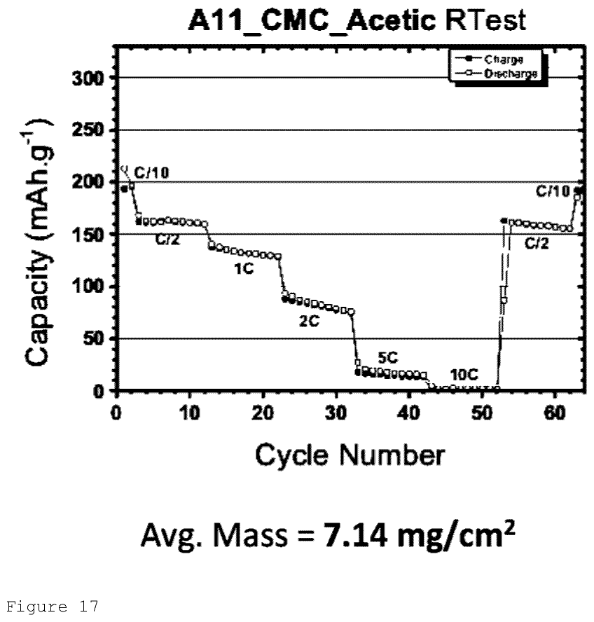

FIG. 17 shows a graph of the test.

Example 30, anode AT2 produced via aqueous processing using carboxy methyl cellulose (CMC) as a binder. pH adjustment with acetic acid and additional carbon nanotubes to enhance anode conductivity

A pure anatase spray dried powder was obtained in the manner of example 5, that was subsequently calcined at 500° C. for 2 hours in air. The powder so obtained was then sieved through a 25 micron mesh and the material that came through the mesh was used in this example. The average particle size was 15 microns and the angle of repose was below 30°. The tap density was 1.5 g/cm³.

2.76 g of the vacuum dried powder was mixed together with 0.148 g of carbon black, 1.52 g of “Tuball™ Batt H₂O” dispersion, 2.53 g of water, and 6.98.g of a solution containing 1.5 wt % Daicel CMC 2200 and 2.45 wt % acetic acid. A TMAX Battery Equipment TMAX-ITT-300S centrifugal mixer was used, with a multistep program. Each step comprised 20 mins mixing at 2000 rpm and 1 minute degassing under vacuum. In the first step the carbon black, Tuball™ dispersion and acidified CMC solution were mixed, with half of the anatase added in the second step and half added in the third step. The additional water was added with the anatase to control viscosity. The total mass of solids was 3.00 g. The slurry weight was 12.93 g. After mixing the slurry was coated using a 200 micron gap applicator bar onto a copper foil and subsequently dried at 60° C. for 3 hours to obtain a coating composition as follows 91.3 wt % TiO₂, 4.9 wt % carbon black, 0.2 wt % CNTs and 3.6 wt % CMC. Electrodes were made by punching 14 mm circular discs of the dried cast with an area of 1.5394 cm², and total active mass of approx. 0.0096 g. The total mass of the electrode plus current collector was approx. 0.034 g. The areal active mass was approx. 0.006 g/cm².

Half-cell coin cells were assembled using these anodes together with a polypropylene separator and a 16 mm lithium disc cut to fit into a 2032 coin cell. 70 μl of electrolyte was used, of composition 1M LiPF₆ in 50:50 EC: DEC. The coin cell was then cycled according to a rate programme whereby a theoretical capacity for the active material of 330 mAh/g was used to set the currents in terms of C rates. The following sequence of currents was then applied to the coin cell to assess the rate capability of the cell: 0,1C 2 full lithiation/delithiation cycles; 0.5C 10 cycles; 1C 10 cycles; 2C 10 cycles; 5C 10 cycles; 10C 10 cycles then followed by 0,5C again for 10 cycles and 2 cycles at 0.1 C.

The following results were obtained during rate testing for anode AT2 performed in duplicate on two separate coin cells, averaging the data:
First cycle efficiency: 87%; Capacities—0.1C 182 mAh/g; 0.5C 153 mAh/g; 1C 138 mAh/g; Following the testing sequence, recovered capacity at 0.5 C was 163 mAh/g and at 0.1C was 191 mAh/g.

Example 30b, anode produced by aqueous processing washed powders using carboxy methyl cellulose (CMC) as a binder

A pure anatase spray dried powder was obtained in the manner of example 5, that was subsequently calcined at 500° C. for 2 hours in air. The powder so obtained was then sieved through a 25 micron mesh and the material that came through the mesh was used in this example. The average particle size was 15 microns and the angle of repose was below 30°. The tap density was 1.5 g/cm³.

Prior to processing into a battery electrode, the powder was washed several times with purified H₂O (18MΩ resistance) filtered and purified with a Milli-Q™ water purification system to control pH. After washing the pH of 40 ml of water containing 1g of TiO₂ was pH=9.4.

0.7 g of washed powder (after vacuum drying) 2.76 g of the vacuum dried powder was mixed together with 0.2 g of carbon black, 0.19 g of water, and 6.64.g of a solution containing 1.5 wt % Daicel CMC 2200. A TMAX Battery Equipment TMAX-ITT-300S centrifugal mixer was used, with a multistep program. Each step comprised 20 mins mixing at 2000 rpm and 1 minute degassing under vacuum. In the first step the carbon black, and CMC solution were mixed, with half of the anatase added in the second step and half added in the third step. The additional water was added with the anatase to control viscosity. Following centrifugal mixing, the slurry was transferred to a shaker mill (Retsch MM400) for high energy mixing. The slurry was mixed in a 10 mm sample holder with a 10 mm diameter steel ball, at a frequency of 20 Hz for 10 mins.

The total mass of solids was 3.00 g. The total mass of solids was 1g and the slurry mass was 0.93 g. After mixing the slurry was coated using a 200 micron gap applicator bar onto a copper foil and subsequently dried at 60° C. for 3 hours to obtain a coating composition as follows 70 wt % TiO₂, 20 wt % carbon black, and 10 wt % CMC. Electrodes were made by punching 14 mm circular discs of the dried cast with an area of 1.5394 cm², and total active mass of approx. 0.0025g. The total mass of the electrode plus current collector was approx. 0.012g. The areal active mass was approx. 0.0016 g/cm².

Half-cell coin cells were assembled using these anodes together with a polypropylene separator and a 16 mm lithium disc cut to fit into a 2032 coin cell. 70 μl of electrolyte was used, of composition 1M LiPF₆ in 50:50 EC: DEC. The coin cell was then cycled according to a rate programme whereby a theoretical capacity for the active material of 330 mAh/g was used to set the currents in terms of C rates. The following sequence of currents was then applied to the coin cell to assess the rate capability of the cell: 0,1C 2 full lithiation/delithiation cycles; 0.5C 10 cycles; 1C 10 cycles; 2C 10 cycles; 5C 10 cycles; 10C 10 cycles then followed by 0,5C again for 10 cycles and 2 cycles at 0.1 C.

The following results were obtained during rate testing for the anode performed in triplicate on three separate coin cells, averaging the data:
First cycle efficiency: 91%; Capacities-0.1C 201 mAh/g; 0.5C 171 mAh/g; 1C 145 mAh/g; Following the testing sequence, recovered capacity at 0.5 C was 164 mAh/g and at 0.1C was 196 mAh/g.

Examples 18-30 are summarized in the below tables. Various measurements were made for each sample and the results are summarized in the tables 4 and 5.

The mesopore volume was always measures according ISO 15901-2:2006,

The primary particle size distribution was first determined according to ISO 19749:2023, then the average particle size was determined from the particle size distribution according to ISO 9276-2:2014 using the method of moments.

The secondary particle size distribution was first determined according to ISO 19749:2023, then the average particle size was determined from the particle size distribution according to ISO 9276-2:2014 using the method of moments.

The tap density was always measured according to the method described by Carson et al in ASM Handbook, Volume 7: Powder Metal Technologies and Applications P. W. Lee, Y. Trudel, R. Iacocca, R. M. German, B. L. Ferguson, W. B. Eisen, K. Moyer, D. Madan, and H. Sanderow, editors, p 287-301 (1998).

The angle of repose was always measured according to the fixed base cone method described by Carlson et al in ASM Handbook, Volume 7: Powder Metal Technologies and Applications P. W. Lee, Y. Trudel, R. Iacocca, R. M. German, B. L. Ferguson, W. B. Eisen, K. Moyer, D. Madan, and H. Sanderow, editors, p 287-301 (1998).

The BET surface area was always measured according to ISO 9277:2010.

For the dopants the percentages are given in at %, which is interpreted as a fraction of atoms.

### Example 31

The acidic dispersion obtained as described in example 2 was split into parts A and B and C and D. Part D formed the material obtained in example 6. Part A was also spray dried in the manner of example 6. Part C was also spray dried in the manner of example 6, but with added monoethanolamine during neutralization to reduce viscosity. Part D was dried the manner of example 16, i.e. without spray drying. The comparative chloride contents were Part A: <100 ppm; Part B 60 ppm; Part C 20 ppm and part D 194 ppm.

### Example 32

A powder was obtained as described in example 8 from an acidic dispersion made as described in example 4. After washing the powder in the manner of example 8, the chloride content was found to be 1400 ppm.

### Example 33

The powder used in example 6 was made into an electrode and half cell as described in example 10 with and without addition of carbon nanotubes in the slurry. The resulting improvement in cycling was a two-fold increase in capacity at 2C, 5C and 10C rates.

TABLE 4

| | | | ICP- | | |
|---|---|---|---|---|---|
| Sample | Description | Raman | AES | BET | |
| LH-15- | Nb 10 at %, | Pure | 5.4 | 129.19 | m²/g |
| 500-2H | calcined at | anatase | at % | | |
| | 500° C. for 2 | | Nb | | |
| | hours | | | | |
| LH-15- | Nb 10 at %, | Pure | nm | 97.56 | m²/g |
| 600-2H | calcined at | anatase | | | |
| | 600° C. for 2 | | | | |
| | hours | | | | |
| GR-22- | Zn 10 at %, | Pure | 1.6 | 110.2 | m²/g |
| 500-2H | calcined at | anatase | at % | | |
| | 500° C. for 2 | | Zn | | |
| | hours | | | | |
| GJ-02- | Fe 10 at %, | Pure | nm | nm | |
| 500-2H | calcined at | anatase | | | |
| | 500° C. for 2 | | | | |
| | hours | | | | |
| GJ-01- | Sn 10 at %, | Pure | nm | nm | |
| 500-2H | calcined | anatase | | | |
| | 500° C. for 2 | | | | |
| | hours | | | | |
| JK-01- | Mo 10 at %, | nm* | 9.16 | 106.6 | m²/g |
| 500-2H | calcined | | at % | | |
| | 500° C. for 2 | | Mo | | |
| | hours | | | | |
| JK-04- | Ta 8 at % | nm | 4.3 | 112.9 | m²/g |

| | | | | |
|---|---|---|---|---|
| 500-2H | calcined 500° C. | | at % | |
| | for 2 | | | |
| | hours | | | |
| GL-06- | N-doped | Pure | nm | nm |
| urea- | anatase | anatase | | |
| 400 | calcined 400 | | | |
| | 1 hour | | | |
| GR-31 | N-doped | nm | nm | nm |
| | anatase | | | |
| | calcined 500 | | | |
| | 2 hour | | | |
| GF-01 | Anatase 180 | Pure | nm | nm |
| | min cooking | anatase | | |
| GR-23 | Anatase cooke | Pure | nm | nm |
| | at 105 C. | anatase | | |
| GR-32 | High | nm | nm | nm |
| | crystallinity | | | |
| | etched T-2022 | | | |

TABLE 5
Half cell

| Sample | 0.1 C | 0.5 C | 1 C | 2 C | 5 C | 10 C | 1st Ef |
|---|---|---|---|---|---|---|---|
| LH-15-500-2H | 202 | 173 | 146 | 118 | 84 | 58 | 86 |
| LH-15-600-2H | 203 | 181 | 159 | 132 | 100 | 71 | 88 |
| GR-22-500-2H | 219 | 197 | 180 | 157 | 120 | 84 | 89 |
| GJ-02-500-2H | 205 | 172 | 156 | 136 | 101 | 72 | 77 |
| GJ-01-500-2H | 166 | 78 | 31 | 17 | 8 | 3 | 73 |
| JK-01-500-2H | 197 | 166 | 143 | 96 | 9 | 0 | 03 |
| JK-04-500-2H | nm | nm | nm | nm | nm | nm | nm |
| GL-06-urea-400 | nm | nm | nm | nm | nm | nm | nm |
| GR-31 | 210 | 186 | 172 | 150 | 115 | 75 | 90 |
| GF-01 | nm | nm | nm | nm | nm | nm | nm |
| GR-23 | nm | nm | nm | nm | nm | nm | nm |
| GR-32 | 210 | 189 | 177 | 157 | 121 | 79 | 86 |

nm = not measured

1. A calcined powder, wherein the powder comprises secondary particles, wherein the secondary particles are comprised of primary particles, wherein the primary particles comprise titanium dioxide, wherein the primary particles have a size in the interval 5-20 nm,
wherein the secondary particles comprise mesopores formed by a space between the primary particles, wherein the mesopores have a volume in the range 0.1-0.5 cm³/g and a size in the range 2-15 nm,
wherein the tap density of the calcined powder is in the range 1.0-1.9 g/cm³,
wherein the powder has an angle of repose of 28.5° or less,
wherein the powder has a BET surface area (A) expressed in m²/g and fulfilling the equation
$$A \geq 420 - 262 ρ$$
wherein ρ is the tap density expressed in g/cm³.

2. The calcined powder according to claim 1, wherein the calcined powder comprise at least one selected from the group consisting of carbon nanotubes, carbon nanofibers, and carbon nanoparticles.

3. The calcined powder according to claim 1, wherein less than 10% of the number of atoms of Ti in the calcined powder is substituted by at least one selected from the group consisting of Zr, Nb, Ta, Hf, Cr, Fe, Mo, V, W, In, Sn, and Ta.

4. The calcined powder according to claim 1, wherein less than 10% of the number of atoms of Ti in the calcined powder is substituted by Zn.

5. The calcined powder according to claim 1, wherein less than 10% of the number of atoms of O in the calcined powder is substituted by at least one selected from the group consisting of N, P, C, S, and F.

6. The calcined powder according to claim 1, wherein the secondary particles have a size in the interval 1-50 μm.

7. The calcined powder according to claim 1, wherein at least a part of the surfaces of the primary particles comprise at least one selected from the group consisting of Zn, Al, Si, Zr, Y, Sn, and oxides thereof.

8. A battery anode for at least one selected from the group consisting of a lithium ion battery and a sodium ion battery, wherein the battery anode comprises a calcined powder according to claim 1.

9. The battery anode according to claim 8, wherein the anode comprises at least one selected from the group consisting of lithium titanium oxide (LTO), titanium dioxide in bronze phase (TiO₂(B)).

10. The battery anode according to claim 8, wherein the anode comprises at least one oxide selected from the group consisting of titanium oxide and niobium oxide.

11.-16. (canceled)

17. A method for manufacturing a calcined powder, the method comprising the steps of:
a providing at least one titanic acid with the general formula [TiOₓ(OH)₄₋₂ₓ]ₙ and soluble in at least one selected from the group consisting of TiOCl₂, TiCl₄, and HCl, and dissolving it in a solution comprising at least one selected from the group consisting of TiOCl₂, TiCl₄, and HCl, wherein the pH of the solution is lower than 1,
b heating to a temperature in the interval 68-110° C., wherein the heating is performed with at least 0.3° C./min,
c. holding the temperature in the temperature 68-110° C. interval during 1-180 minutes, during stirring to form a dispersion comprising primary nanoparticles comprising anatase, wherein the primary particles have a size in the interval 5-20 nm,
d. cooling the dispersion,
e. adjusting the ion content of the dispersion comprising primary nanoparticles
f. spray drying the dispersion to obtain a powder,
wherein the powder after step f) comprises secondary particles comprised of primary particles,
g. drying the powder and then calcining the powder in a temperature in the range 300-650° C. to obtain a calcined powder comprising secondary particles comprised of primary particles,
wherein the powder is washed in water to decrease the content of ions in the powder at least before or after step g).

18. The method according to claim 17, wherein the at least one titanic acid with the general formula [TiOₓ(OH)₄₋₂ₓ]ₙ in step a) is provided by increasing the pH of at least one solution comprising at least one selected from the group consisting of TiOCl₂, and TiCl₄.

19. The method according to claim 17, wherein the at least one titanic acid with the general formula [TiOₓ(OH)₄₋₂ₓ]ₙ in step a) is provided by increasing the pH of at least one solution comprising at least one selected from the group consisting of TiOSO₄, and Ti₂SO₄.

20.-29. (canceled)

30. The method according to claim 17, wherein at least one of carbon nanotubes, carbon nanoparticles and carbon nanofibers is added at any point after step a) and before step g).

31. (canceled)

32. The method according to claim 17, wherein at least one ingredient is added before, during or after the spray drying, the at least one ingredient when calcined forming conductive carbon deposits that enhance the intrinsic electronic conductivity within the particles.

33. The method according to claim 17, wherein the calcination is performed in a reducing atmosphere with at least one reducing additive.

34.-35. (canceled)

36. The method according to claim 17, wherein the calcination in step g) is carried out in essentially oxygen free environment with maximum 0.3 wt % oxygen, and wherein the at least one alpha hydroxy acid is added at any point before step g).

37. The method according to claim 17, wherein at least a part of the surfaces of the primary particles are coated, wherein the step is performed at any point from before step d) to after step g).

38.-50. (canceled)

51. The method according to claim 17, further comprising treating the dispersion to neutralize the dispersion to a pH in the range from 4.5 to 5.5 before step f).
